(19) United States
(12) Patent Application Publication
(10) Pub. No.: US 2022/0089886 A1
(43) Pub. Date: Mar. 24, 2022

(54) ENZYME FUNCTIONALIZED COATING COMPOSTIONS

(71) Applicants: Yun HAN, San Diego, CA (US); BASF SE, Ludwigshafen an Rhein (DE)

(72) Inventors: Yun Han, San Diego, CA (US); Adrienne Huston Davenport, San Diego, CA (US); Dejan Caglic, San Diego, CA (US); Michael Krayer, Charlotte, NC (US); Tuan Tran, San Diego, CA (US)

(21) Appl. No.: 17/251,751

(22) PCT Filed: Jun. 24, 2019
(86) PCT No.: PCT/US19/38685

§ 371 Date: Dec. 11, 2020

Related U.S. Application Data
(60) Provisional application No. 62/691,278, filed on Jun. 28, 2018.

(51) Int. Cl. C09D 7/65; C09D 7/61

(52) U.S. Cl. CPC C09D 7/65; C09D 7/61

(57) ABSTRACT

Disclosed herein are coating compositions comprising one or more enzymes that retain enzymatic activity following film formation. Uses of such functionalized coating compositions to confer bioactive properties to surfaces are also provided. Methods of enhancing in-film enzyme activity by modulation of filler type, pigment volume concentration (PVC), neutralizer type, and/or coalescing agent level are also provided.

### CROSS-REFERENCE TO RELATED APPLICATIONS

The present application claims the benefit of priority to U.S. Application No. 62/691,278, filed on Jun. 28, 2018, the contents of which are incorporated herein in their entirety.

### BACKGROUND

### Field

The present application relates to functionalized coating compositions wherein the biological activity of one or more enzymes contained therein confers one or more desirable properties to a surface (e.g., stain resistance). One aspect relates to paints comprising one or more enzymes that retain in-film enzyme activity.

### Description of Related Art

Various strategies exist for formulating coating compositions, such as paints, for particular surfaces and applications. However, to date, there has been limited success in using enzymes and other biological molecules to confer properties to paint films, as current methods inconveniently require the use of whole cell particular matter or enzyme immobilization and/or modification. There remains a need for enzyme-functionalized coating compositions that are inexpensive, easy to manufacture, and work effectively across a broad range of enzymes and applications.

### SUMMARY

In several embodiments, coating compositions are provided. In several embodiments, the coating composition comprises a binder, a pigment, and one or more enzymes. In several embodiments, the coating composition is capable of forming a film when applied to a surface. In some embodiments, the pigment volume concentration (PVC) of the coating composition is below the critical pigment volume concentration (CPVC). In some embodiments, at least one of the one or more enzymes retains at least about 5% activity in-film (e.g., 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, and ranges in between). In some embodiments, the one or more enzymes retain at least about 30% activity in the coating composition before it is applied to the surface. In some embodiments, the one or more enzymes comprise an oxidoreductase, a transferase, a hydrolase, a lyase, an isomerase, a ligase, or any combination thereof. The hydrolase can be, for example, a lactonase. In some embodiments, the one or more enzymes comprise a mannanase, a cellulase, an amylase, a lipase, a protease, a lactonase, a laccase, a urease, or any combination thereof. In some embodiments, at least one of the one or more enzymes has one or more of the following properties: is not chemically modified, is in its native form, is incorporated directly in the coating composition, is not immobilized on a support, and is not covalently attached to the binder prior to film formation. In some embodiments, the coating composition does not comprise whole cell particulate material. In some embodiments, the PVC is about 0.001% to about 70% (e.g. 0.001%, 0.005%, 0.01%, 0.03%, 0.05%, 0.07%, 0.09%, 0.1%, 0.11%, 0.13%, 0.15%, 0.17%, 0.19%, 0.2%, 0.5%, 0.7%, 1%, 2%, 5%, 10%, 20%, 30%, 40%, 50%, 60%, 70%, and ranges in between). In some embodiments, about 0.001 wt % to about 20 wt % (e.g. 0.001%, 0.005%, 0.01%, 0.03%, 0.05%, 0.07%, 0.09%, 0.1%, 0.11%, 0.13%, 0.15%, 0.17%, 0.19%, 0.2%, 0.5%, 0.7%, 1%, 2%, 5%, 10%, 20%, and ranges in between) of the coating composition is the one or more enzymes.

In some embodiments, the coating composition comprises an industrial coating, a marine coating, an automotive coating, an architectural coating, or any combination thereof. In some embodiments, the coating composition comprises a paint, a lacquer, a printing ink, a varnish, a shellac, a stain, a textile finish, a sealing compound, a water repellent coating, or any combination thereof. In some embodiments, the surface comprises wood, metal, masonry, plaster, stucco, plastic, or any combination thereof. In some embodiments, the coating composition comprises a water-borne coating, and wherein the water-borne coating is a latex coating. In some embodiments, the activity of the one or more enzymes confers one or more of the following properties to the coating composition: self-cleaning, stain resistance, stain blocking, tannin blocking, adhesion, paint processing aid, formaldehyde abatement, odor abatement, corrosion resistance, anti-microbial, anti-biofilm, de-greasing, de-icing, decontamination, strippable coating, faster curing, and/or lower VOC content.

In some embodiments, the binder comprises an oil-based binder, a polyester resin, a modified cellulose, a polyamide, an amino resin, a urethane binder, a phenolic resin, an epoxy resin, a polyhydroxyether binder, an acrylic resin, a polyvinyl binder, a rubber resin, a bituminous binder, a polysulfide binder, a silicone binder, an organic binder, or any combination thereof. In some embodiments, the binder comprises or is derived from vinyl monomers, butadiene copolymers, vinyl acetate copolymers, styrene acrylic copolymers, acrylic copolymers, or any combination thereof. Examples of binders include, but are not limited to Acronal PLUS 4670, Acronal EDGE 4750, Joncryl PRO 1522, and Joncryl 1524.

In some embodiments, the pigment comprises a color pigment, an extender pigment (a filler), a corrosion resistance pigment, a camouflage pigment, or any combination thereof. In some embodiments, the color pigment comprises or is derived from an organic pigment, an inorganic pigment, an anionic pigment dispersion, a cationic pigment dispersion, azo chelate pigments, insoluble azo pigments, condensed azo pigments, phthalocyanine pigments, indigo pigments, perinone pigments, perylene pigments, dioxane pigments, quinacridone pigments, isoindolinone pigments, metal complex pigments, chrome yellow, yellow iron oxide, iron oxide red, carbon black and titanium dioxide; and extender pigments such as calcium carbonate, barium sulfate, clay, talc, TiO₂ (anatase), TiO₂ (rutile), clay (aluminum silicate), CaCO₃ (ground), CaCO₃ (precipitated), aluminum oxide, silicon dioxide, magnesium oxide, talc (magnesium silicate), baryte (barium sulfate), zinc oxide, zinc sulfite, sodium oxide, potassium oxide, MINEX, CELITE, ATOMITE, or any combination thereof. In some embodiments, the extender pigment comprises or is derived from attapulgite clay, TiO₂, CaCO₃, kaolin clay, nepheline syenite, (25% nepheline, 55% sodium feldspar, and 20% potassium feldspar), feldspar (an aluminosilicate), diatomaceous earth, calcined diatomaceous earth, talc (hydrated magnesium silicate), aluminosilicates, silica (silicon dioxide), alumina (aluminum oxide), alumina trihydrate (ATM), mica (hydrous aluminum potassium silicate), pyrophyllite (aluminum silicate hydroxide), perlite, baryte (barium sulfate), wollastonite (calcium metasilicate), Mg₃Si₄O₁₀(OH)₂, BaSO₄, (NaK)Al₂(AlSi₃)O₁₀(OH)₂, CaCO₃, Al₂Si₂O₅(OH)₄, SiO₂, KAl₂(AlSi₃O₁₀)(OH)₂, or any combination thereof.

In some embodiments, coating composition further comprises one or more additives selected from the group comprising a neutralizer, a rheology modifier, a dispersant, a coalescing agent, a plasticizer, a defoamer, a stabilizer, a humectant, a wetting agent, a dye, a biocide, and a combination thereof. In some embodiments, the rheology modifier is selected from the group comprising hydrophobically modified ethylene oxide urethane (HEUR) polymers, hydrophobically modified alkali soluble emulsion (HASE) polymers, hydrophobically modified hydroxyethyl celluloses (HMHECs), hydrophobically modified polyacrylamide, acrylic copolymer dispersions, urethanes, hydroxyethyl cellulose, guar gum, jaguar, carrageenan, xanthan, acetan, konjac, mannan, xyloglucan, urethanes, and a combination thereof. In some embodiments, the coalescing agent is selected from the group comprising ethylene glycol monomethyl ether, ethylene glycol monobutyl ether, ethylene glycol monoethyl ether acetate, ethylene glycol monobutyl ether acetate, diethylene glycol monobutyl ether, diethylene glycol monoethyl ether acetate, dipropylene glycol monomethyl ether, propylene glycol n-butyl ether, dipropylene glycol n-butyl ether (DPnB), 2,2,4-trimethyl-1,3-pentanediol monoisobutyrate (Texanol), and a combination thereof. In some embodiments, the coalescing agent is present in an amount of at least about 8.0 wt %, wherein in-film enzyme activity increased by at least about 5% compared to a coating composition comprising the coalescing agents in an amount of less about 6.0 wt %.

In several embodiments, methods of maintaining the in-film activity of an enzyme in a coating composition are provided. In some embodiments, the method comprises adding one or more enzymes to a coating composition comprising a pigment and a binder. In some embodiments, the pigment volume concentration (PVC) of the coating composition is below the critical pigment volume concentration (CPVC). In some embodiments, the enzyme is selected from the group consisting of a mannanase, a cellulase, an amylase, a lipase, a protease, a laccase, a lactonase, and a combination thereof. In some such embodiments, in-film enzyme activity increased by at least about 5% compared to a coating composition with a PVC of less than about 20%. In some embodiments, the enzyme is urease. In some such embodiments, in-film enzyme activity increased by at least about 5% compared to a coating composition with a PVC of less than about 20%.

In several embodiments, methods of using an enzyme-containing coating composition are provided. In some embodiments, the method comprises applying any of the coating compositions provided herein to a surface. In some embodiments, the application of the coating composition to the surface confers one or more of the following properties to the surface: self-cleaning, stain resistance, stain blocking, tannin blocking, wood adhesion, paint processing aid, formaldehyde abatement, odor abatement, corrosion resistance, anti-microbial, anti-biofilm, degreasing, de-icing, decontamination, strippable coating, faster curing, and lower VOC content.

### BRIEF DESCRIPTION OF THE FIGURES

FIG. 1 depicts a schematic representation of a procedure for “harsh” enzyme extraction from dry film according to several embodiments disclosed herein.

FIGS. 2A and 2B depict data related to enzyme activity recovery from Group 1 film and liquid paint samples 1-8 with high enzyme addition (−0.19% cellulase; −48 U/g; Set 3) and low enzyme addition (0.0036% cellulase; −0.9 U/g; Set 1), respectively. FIG. 2C depicts data related to the protein quantity of extracted Set 3 film samples 1-8 by SDS-PAGE. FIG. 2D depicts data related to the specific activity of extracted Set 3 film samples 1-8. Specific activity=enzyme activity/enzyme quantitation. Paint samples marked “A” and “B” have a pigment volume concentration (PVC) of 40% and 20%, respectively.

FIGS. 3A and 3B depict data related to recovered enzyme activity from “harsh” extraction of Group 2 wet paint samples and dry film samples, respectively. The latex type in the paint formulation is indicated below the sample name in FIG. 3A. The pigment volume concertation (PVC) of the formulations is indicated in FIG. 3B. The relative levels of coalescing agents DPnB and Texanol in the v3 formulations are indicated. Different neutralization agents (NH₃ or NaOH) were used in v6 and v7, as indicated in FIG. 3B. No enzyme was added in v1, v2, v3, v4* and v5* samples.

FIGS. 4A and 4B depict data related to enzyme quantification following “harsh” extraction of Group 2 wet paint samples and dry film samples, respectively. The latex type in the paint formulation is indicated below the sample name in FIG. 4A. The pigment volume concertation (PVC) of the formulations is indicated in FIG. 4B. The relative levels of coalescing agents DPnB and Texanol in the v3 formulations are indicated. The neutralization agents (NH₃ or NaOH) used in v6 and v7 are indicated in FIG. 4B.

FIGS. 5A and 5B depict data related to the specific activity of extracted enzyme (cellulase) from Group 2 wet paint samples and dry film samples, respectively.

FIG. 6A depicts a schematic representation of a procedure for measuring in-film enzymatic activity according to several embodiments disclosed herein.

FIG. 6B depicts data related to the in-film enzymatic activity of Group 1 Set 1 paint samples that were assayed according to the procedure outlined in FIG. 6A. Wells with substrate only and film samples loaded with no enzyme were employed as controls.

FIG. 7A depicts a schematic representation of a procedure for “soft” enzyme extraction from film and subsequent activity analysis according to several embodiments disclosed herein. FIG. 7B depicts the cellulase extraction over time of a Group 1 Set 3 3B film sample assayed according to the procedure outlined in FIG. 7A.

FIG. 8A depicts a schematic representation of a procedure for multiple cycles of buffer wash/“soft” enzyme extraction from film and subsequent activity analysis according to several embodiments disclosed herein. FIG. 8B depicts data related to cumulative cellulase activity over 30 minutes (six wash cycles) from a film sample assayed according to the procedure outlined in FIG. 8A. FIG. 8C depicts data related to cellulase activity extraction following six 5-minute washes at room temperature (Washes 1-6) and two 30-minute incubations at 60° C. (Heats 1-2).

FIGS. 9A and 9B depict schematic representations of an in-film total activity assay and a soft extraction assay/in-film residual activity assay, respectively, according to several embodiments disclosed herein. FIG. 9C depicts a 5% agar media containing 0.1% azo-barley glucan incubated with paint film samples that have been loaded with 0.1% cellulase (2, 4, 5, 7, 8, 9, 14, 15, 16, 17) or no enzyme (1, 3, 6, 10, 11, 12, 13) as indicated in Table 5.

FIGS. 10A, 10B, and 100 depict data related to in-film total activity, soft extraction activity, and residual activity of cellulase detected in Group 2 dry film samples, respectively. Latex type of the paint formulation is indicated below the sample name in FIG. 10A. The pigment volume concertation (PVC) is indicated in FIG. 10A. The relative levels of coalescing agents DPnB and Texanol in the v3 formulations are indicated in FIGS. 10A and 10B. The neutralizing agents NH₃ or NaOH present in the v6 and v7 paint formulations, respectively, are indicated in FIG. 10B.

FIG. 11 depicts data related to the mass balance of in-film activity of Group 2 dry film samples. The pigment volume concertation (PVC), latex type, relative levels of coalescing agents, and the neutralizing agents present in the paint formulations are indicated.

FIGS. 12A and 12B depict data related to enzyme activity detected by “harsh” extraction and in-film assays of Group 2 dry film samples, respectively.

FIGS. 13A, 13B, and 13C depicts data related to the in-film enzyme activity of Group 2 dry film samples visualized by the agar plate method after 3, 7, and 22 hours incubation at 37° C., respectively. Agar media containing 5% agar and 0.1% azo-barley glucan were incubated with paint film samples that have been loaded with 0.1% cellulase (2, 4, 5, 7, 8, 9, 14, 15, 16, and 17) or no enzyme (1, 3, 6, 10, 11, 12, and 13).

FIGS. 14A and 14B depict data related to enzyme activity detected by “harsh” extraction and total in-film activity assays of Group 1 Set 1 dry film samples, respectively.

FIGS. 15A and 15B depict data related to enzyme activity detected by total in-film total activity assays and “soft” extraction of Group 1 Set 1A dry film samples, respectively.

FIGS. 16A and 16B depict data related to enzyme activity detected by “harsh” extraction and total in-film activity assays of Group 1 Set 3 dry film samples, respectively.

FIGS. 17A and 17B depict data related to enzyme activity detected by total in-film total activity assays and “soft” extraction of Group 1 Set 3 dry film samples, respectively.

FIG. 18A depicts a schematic representation of the enzyme-catalyzed reaction underlying the red starch agar plate assay according to several embodiments disclosed herein. FIG. 18B depicts a red starch agar plate incubated with the indicated samples at 30° C. for 7 hours.

FIG. 19A depicts a schematic representation of the enzyme-catalyzed reaction underlying the milk agar plate assay according to several embodiments disclosed herein. FIG. 19B depicts a milk agar plate incubated with the indicated samples at 30° C. for 3 hours.

FIG. 20A depicts a schematic representation of the enzyme-catalyzed reaction underlying the vegetable oil agar plate assay according to several embodiments disclosed herein. FIG. 20B depicts a vegetable oil agar plate incubated with the indicated samples at 30° C. for 3 hours. FIG. 20C depicts a vegetable oil agar plate incubated with the indicated samples at 30° C. for 4 hours, with the film removed at the end of the incubation.

FIG. 21A depicts a schematic representation of the enzyme-catalyzed reaction underlying the Syringaldazine (SGZ) agar plate assay according to several embodiments disclosed herein. FIG. 21B depicts a SGZ agar plate incubated with the indicated samples at 30° C. for 4 hours.

FIG. 22A depicts a SGZ agar plate incubated with the indicated films loaded with either 40 U/mL laccase or without enzyme (−Enz). FIG. 22B depicts a milk agar plate incubated with the indicated films loaded with either 0.1% protease or without enzyme (−Enz). FIG. 22C depicts a red starch agar plate incubated with the indicated films loaded with either 1% alpha-amylase or without enzyme (−Enz). FIG. 22D depicts a vegetable oil agar plate incubated with the indicated films loaded with lipase (0.5%, 1%, or 4%) or without enzyme (−Enz). Films comprise a PVC of either 40% (OA samples) or 20% (OB samples). Films without enzyme (−Enz) were added as a negative control. The top and bottom rows depict color and greyscale images of the plate, respectively.

FIG. 23A depicts a schematic representation of the enzyme-catalyzed reaction underlying the colorimetric in-film amylase activity assay according to several embodiments disclosed herein. FIG. 23B depicts the removal of an interior region (of a diameter of 0.31 cm) from a paint film sample (with a 0.6 cm diameter) to allow light to pass through. FIG. 23C depicts the placement of a paint film sample that has been configured to allow light to pass through in a 96-well plate

FIGS. 24A-C depict schematic representations of an in-film total assay, a soft extraction assay and an in-film residual assay (FIGS. 24A, 24B, and 24C, respectively) according to several embodiments disclosed herein.

FIGS. 25A-B depicts SGZ agar plates and milk agar plates (FIGS. 25A and 25B, respectively) incubated with films loaded with either enzyme (“+”; 82.4 U/mL amylase and 0.1% protease, respectively) or without enzyme (“−”). Color and grey scale images are depicted. Films comprise a PVC of either 40% (A & C samples) or 20% (B & D samples) and a filler of Minex 4 (A & B samples) or Celatom (C & D samples).

FIG. 26 depicts data related to the in-film activity of laccase (82.4 U/g) in the indicated film samples. In-film enzyme activity was derived from an in-film total assay, a soft extraction assay or an in-film residual assay as indicated. Films comprise a PVC of either 40% (A & C samples) or 20% (B & D samples) and a filler of Minex 4 (A & B samples) or Celatom (C & D samples).

FIG. 27 depicts data related to the in-film activity of protease (0.2 mg/g) in the indicated film samples. In-film enzyme activity was derived from an in-film total assay, a soft extraction assay or an in-film residual assay as indicated. Films comprise a PVC of either 40% (A & C samples) or 20% (B & D samples) and a filler of Minex 4 (A & B samples) or Celatom (C & D samples).

FIG. 28 depicts data related to the in-film activity of amylase (20 mg/g) in the indicated film samples. In-film enzyme activity was derived from an in-film total assay, a soft extraction assay or an in-film residual assay as indicated. Films comprise a PVC of either 40% (A & C samples) or 20% (B & D samples) and a filler of Minex 4 (A & B samples) or Celatom (C & D samples).

FIG. 29 depicts data related to the in-film activity of lipase (2 mg/g) in the indicated film samples. In-film enzyme activity was derived from an in-film total assay, a soft extraction assay or an in-film residual assay as indicated. Films comprise a PVC of either 40% (A & C samples) or 20% (B & D samples) and a filler of Minex 4 (A & B samples) or Celatom (C & D samples).

FIG. 30 depicts data related to the in-film activity of urease (4 U/g) in the indicated film samples. In-film enzyme activity was derived from an in-film total assay, a soft extraction assay or an in-film residual assay as indicated. Films comprise a PVC of either 40% (v5-40) or 20% (v5-20) and a filler of Duramite.

FIGS. 31A-B depict low and high magnification confocal laser scanning microscopy images of a cross section of paint film comprising Minex filler [(NaK)Al₂(AlSi₃)O₁₀(OH)₂]) and fluorescein-labelled cellulase (FIG. 31A and FIG. 31B, respectively).

FIGS. 32A-B depict low and high magnification confocal laser scanning microscopy images of a cross section of paint film comprising Duramite filler (CaCO₃) and fluorescein-labelled cellulase (FIG. 32A and FIG. 32B, respectively).

FIGS. 33A-B depict low and high magnification confocal laser scanning microscopy images of a bottom view of paint film comprising Minex filler [(NaK)Al₂(AlSi₃)O₁₀(OH)₂]) and fluorescein-labelled cellulase (FIG. 33A and FIG. 33B, respectively).

FIGS. 34A-B depict low and high magnification confocal laser scanning microscopy images of a bottom view of paint film comprising Duramite filler (CaCO₃) and fluorescein-labelled cellulase (FIG. 34A and FIG. 34B, respectively).

FIGS. 35A-B depict confocal laser scanning microscopy visualization of enzyme activity in paint film comprising Minex filler [(NaK)Al₂(AlSi₃)O₁₀(OH)₂]), fluorescein-labelled cellulase and 40% PVC (FIG. 35A) or 20% PVC (FIG. 35B).

FIG. 36 depicts data of lactonase activity recovery (substrate-to-product conversion %) in solution extracts from dry paint film (at two different pigment volume concentrations) containing lactonase. Solutions with fresh lactonase (+ solution control), no lactonase (−solution control), and extracted dry film without lactonase added (−dry film control) served as controls.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, can be arranged, substituted, combined, and designed in a wide variety of different configurations, all of which are explicitly contemplated and make part of this disclosure.

### Coating Compositions

There are provided, in some embodiments, coating compositions and methods for the use of enzymes as components of coating compositions. More specifically, there are provided compositions and methods for incorporating enzymes into coating compositions in a manner to retain one or more enzymatic activities conferred by such enzyme within a paint film. In some embodiments, embedded enzymes retain activity after being directly admixed with a coating composition. Further, in some embodiments, the embedded enzymes retain activity after the coating composition is applied to a surface. In some such embodiments, the one or more enzymes retain activity after film formation occurs (e.g., retains in-film activity). In some embodiments, the in-film activity of an embedded enzyme renders the surface bioactive.

In some embodiments, the coating composition comprises an architectural coating (e.g., a wood coating, a masonry coating, an artist's coating), an industrial coating (e.g., automotive coating, a can coating, sealant coating, a marine coating), a specification coating (a camouflage coating, a pipeline coating, traffic marker coating, aircraft coating, a nuclear power plant coating), or any combination thereof. In some embodiments, the coating composition comprises a paint. In other embodiments, the coating composition comprises a clear coating. In some embodiments, the clear coating comprises a lacquer, a varnish, a shellac, a stain, a water repellent coating, or any combination thereof.

In some embodiments, the coating composition undergoes film formation. In some embodiments, film formation occurs at ambient conditions, baking conditions, UV irradiation, or any combination thereof. In some embodiments, film formation occurs at baking conditions. In some embodiments, baking conditions comprise a temperature between 40-110° C. (e.g., 40° C., 50° C., 60° C., 70° C., 80° C., 90° C., 100° C., 110° C., and ranges in between). In some embodiments, the surface comprises wood, metal, masonry, plaster, stucco, plastic, or any combination thereof. In some embodiments, the coating composition is applied to the surface by spraying, rolling, brushing, spreading, or any combination thereof. In some embodiments, the surface comprises wood, metal, masonry, plaster, stucco, plastic, or any combination thereof. In some embodiments, the coating composition is about 5 μm to about 1500 μm (e.g., 5, 7, 10, 15, 20, 30, 40, 50, 100, 200, 300, 400, 500, 700, 900, 1000, 1250, 1500, and ranges in between) thick upon the surface. In some embodiments, the coating composition comprises a multicoat system comprising 2 to 10 layers (e.g., 2, 3, 4, 5, 6, 7, 8, 9, 10, and ranges in between). In some embodiments, one layer of the multicoat system comprises the one or more enzymes, while in other embodiments a plurality of layers of the multicoat system comprises the one or more enzymes. In some embodiments, the multicoat system further comprises a sealer, a water repellent, a primer, an undercoat, a topcoat, or any combination thereof.

In some embodiments, the coating composition is a non-film forming coating. In some embodiments, the non-film forming coating comprises a non-film forming binder. In some embodiments, the non-film forming coating comprises a coating component in a concentration that is insufficient to produce a solid film. In some embodiments, the coating composition comprises a binder that contributes to thermoplastic film formation, thermosetting film formation, or a combination thereof. In some embodiments, the coating composition produces a temporary film. In some embodiments, the temporary film has a poor resistance to a coating remover, has a poor scrub resistance, a poor solvent resistance, a poor water resistance, a poor weathering property, a poor adhesion property, or any combination thereof.

Several embodiments of the present invention relate to unique functionalized coating compositions. The formulations described herein can be beneficial for use in paints, including architectural coatings and industrial coatings. In several embodiments, coating compositions described herein provides one or more of the following advantages: (i) increased in-film activity; (ii) reduced required amounts of enzyme embedding; (iii) compatibility across broad classes of enzymes (e.g., ureases, mannanases, cellulases, amylase, lipases, protease, lactonase, and/or laccases); (iv) increased half-life in-film; (v) increased specific enzyme activity in-film; (vi) increased enzyme activity in wet paint; (vii) enzyme compatibility across broad classes of fillers; (viii) enzyme compatibility across broad ranges of PVC levels; (ix) enzyme compatibility across varied concentrations and types of neutralizers; (x) in-film enzyme activity absent immobilizing the enzyme on a support; and (xi) embedding of enzymes in native form (e.g., not chemically modified). Furthermore, advantageously, in several embodiments, these improvements are obtained with enzymes incorporated directly in the coating composition, eliminating the need to modify the enzyme or add additional components to maintain enzyme activity. Furthermore, advantageously, in some embodiments, these improvements are obtained with formulations that have high PVC values, enabling enzyme use in coating compositions that cheaper to manufacture.

### Embedded Enzymes

In some embodiments, the compositions and methods herein can produce coating compositions with a bioactivity. Provided herein, in several embodiments, are coating compositions wherein an enzyme's activity is conferred to a surface and/or coating composition via the direct incorporation of an enzyme into the coating composition. In some such embodiments, following application to a surface and subsequent film formation, the enzyme maintains a property, alters a property, and/or confers a property to the surface and/or coating composition. In some embodiments, the enzyme retains at least about 2% A (e.g., 2%, 3%, 4%, 5%, 6%, 7%, 8%, 9%, 10%, 11%, 12%, 13%, 14%, 15%, 20%, 25%, 30%, 40%, 50%, 75%, 100%, and ranges in between) activity in-film. In some embodiments, there are provided enzymes as components of coating compositions which confer an activity or other advantage to the coating composition related to the enzyme. In some embodiments, about 0.001 wt % to about 70 wt % (e.g. 0.001%, 0.005%, 0.01%, 0.03%, 0.05%, 0.07%, 0.09%, 0.1%, 0.11%, 0.13%, 0.15%, 0.17%, 0.19%, 0.2%, 0.5%, 0.7%, 1%, 2%, 5%, 10%, 20%, 30%, 40%, 50%, 60%, 70%, and ranges in between) of the coating composition comprises one or more enzymes. In some embodiments, the coating composition further comprises a substrate and/or cofactor for the enzyme. In some embodiments, the one or more enzymes comprises an oxidoreductase, a transferase, a hydrolase (e.g., a lactonase), a lyase, an isomerase, a ligase, or any combination thereof. In some embodiments, the one or more enzymes comprises a lactonase. In some embodiments, the one or more enzymes comprise a mannanase, a cellulase, an amylase, a lipase, a protease, a laccase, a urease, or any combination thereof. In some embodiments, the application of the coating compositions provided herein to a surface confers one or more of the following properties to the surface and/or coating composition: self-cleaning, stain resistance, stain blocking, tannin blocking, wood adhesion, paint processing aid, formaldehyde abatement, odor abatement, corrosion resistance, anti-microbial, anti-biofilm, degreasing, de-icing, decontamination, strippable coating, faster curing, and/or lower VOC content. In some embodiments, the one or more enzymes comprises a cellulase and the cellulase enzyme activity confers improved wood adhesion to the coating composition. In some embodiments, the coating composition comprises an oxidase and the oxidase enzyme activity confers tannin blocking, stain resistance, or stain blocking to the coating composition. In some embodiments, the coating composition comprises a laccase, and the laccase enzyme activity confers tannin blocking to the coating composition. In some embodiments, the coating composition comprises a lipolytic enzyme that confers a self-degreasing property to a surface.

In some embodiments, the one or more enzymes remain stable in the coating composition for an extended period of time (e.g., months) at ambient conditions. It is contemplated, in some embodiments, the extended period of activity may further comprise time periods in excess of a year. In some embodiments, the enzyme leeches outside of the film while in other embodiments the enzyme remains within the film. In some embodiments, the enzyme is distributed throughout the film. In some embodiments, the enzyme is distributed primarily at the surface of the film.

In some embodiments, the coating composition comprises a combination of active enzymes. The combination of enzymes may be of the same type or of a different type (e.g., a cellulase and a lipase). All iterations of active enzymes may be selected to confer to a coating a combination of bioactivities as desired. In some embodiments, a composition of the present invention may comprise 1 to 100 or more different selected enzymes of interest, including all intermediate ranges and combinations thereof.

In some embodiments, at least one of the one or more enzymes is not immobilized on a support. For example, in some embodiments, none of the enzymes is immobilized on a support. In some embodiments, the coating composition does not comprise a cross-linking agent. In some embodiments, at least one of the enzymes is not chemically modified, for example none of the enzymes is chemically modified. In some embodiments, at least one of the enzymes is in its native form, for example all of the enzymes are in its native form. In some embodiments, at least one of the enzymes is incorporated directly in the coating composition. In some embodiments, at least one of the enzymes is added to the coating composition without immobilization on a support. In some embodiments, the coating composition does not comprise whole cell particulate material. In some embodiments, at least one of the enzymes is not covalently attached to the binder prior to film formation.

### Coating Composition Formulations

In some embodiments, the coating composition comprises a binder, a pigment, a liquid component, and one or more enzymes. In some embodiments, the coating composition further comprises one or more additives, such as, for example, dispersants, coalescing solvents, plasticizers, defoamers, thickeners, stabilizers (additional surfactants and pH modifying agents), wetting agents, dyes, antimicrobial agents (biocides), and any combination thereof. In several embodiments, the coating composition comprises a combination of various combination groups and individual ingredients. In some embodiments, the formulation comprises, consists essentially of or consists of several or all of the following groups of ingredients:

(1) polymers (binders);

(2) liquid components;

(3) pigments;

(4) enzymes;

(5) dispersants;

(6) coalescing solvents;

(7) plasticizers;

(8) defoamers;

(9) neutralizers;

(10) rheology modifiers;

(11) wetting agents;

(12) dyes; and

(13) biocides.

In some embodiments, any one of groups (1)-(3) above is provided in a range of about 0.000001% to about 40.0% (e.g., 0.000001%, 0.00001%, 0.0001%, 0.001%, 0.001%, 0.001%, 0.005%, 0.01%, 0.03%, 0.05%, 0.07%, 0.09%, 0.1%, 0.11%, 0.13%, 0.15%, 0.17%, 0.19%, 0.2%, 0.5%, 1%, 3%, 4%, 5%, 10%, 15%, 20%, 30%, 40%, and ranges in between). In some embodiments, any one of groups (4)-(14) above is provided in a range of about 0.000001% to about 20.0% (e.g., 0.000001%, 0.00001%, 0.0001%, 0.001%, 0.001%, 0.001%, 0.005%, 0.01%, 0.03%, 0.05%, 0.07%, 0.09%, 0.1%, 0.11%, 0.13%, 0.15%, 0.17%, 0.19%, 0.2%, 0.5%, 1%, 3%, 4%, 5%, 10%, 15%, 20%, and ranges in between). In some embodiments, only groups (1)-(4) above are provided. In some embodiments, groups (1)-(4) above are provided and the coating composition further comprises a selection of 1, 2, 3, 4, 5, 6, 7, 8, or 9 of groups (5)-(13). In some embodiments, only groups (1), (2), and (4) above are provided. In some embodiments, groups (1), (2), and (4) above are provided, and the coating composition further comprises a selection of 1, 2, 3, 4, 5, 6, 7, 8, or 9 of groups (5)-(13).

The percentages provided above for the groups (1)-(13) are provided as % m/m in some embodiments. In other embodiments, these ingredients are provided as % w/w, % m/v, % v/v, % m/w, or % w/v. In several embodiments, an effective amount of each enzyme is included in the formulation. An effective amount may be that which confers the desired activit(ies) to the coating composition and/or surface.

As disclosed herein, coating compositions of particular ratios and/or amounts of ingredient groups (1)-(13) can result in synergistic effects in increasing in-film enzyme activity. These synergistic effects can be such that the one or more effects of the coating compositions are greater than the one or more effects of each group ingredient alone at a comparable enzyme dosing level, or they can be greater than the predicted sum of the effects of all of the group ingredients at a comparable enzyme dosing level, assuming that each group ingredient acts independently. The synergistic effect can be about, or greater than about, 5, 10, 20, 30, 50, 75, 100, 110, 120, 150, 200, 250, 350, or 500% better than the effect on in-film enzyme activity observed with inclusion one of the ingredients alone, or the additive effects of each of the ingredients when formulated individually. The effect on enzyme activity can be any of the measurable effects described herein. The coating composition comprising a plurality of ingredients from groups (1)-(13) can be such that the synergistic effect is an enhancement in in-film enzyme activity and that in-film enzyme activity is increased to a greater degree as compared to the sum of the effects of formulating each ingredient, determined as if each ingredient exerted its effect independently, also referred to as the predicted additive effect herein. For example, if a coating composition comprising ingredient (a) yields an effect of a 20% improvement in in-film enzyme activity and a coating composition comprising ingredient (b) yields an effect of 50% improvement in in-film enzyme activity, then a coating composition comprising both ingredient (a) and ingredient (b) would have a synergistic effect if the combination composition's effect on in-film enzyme activity was greater than 70%.

A synergistic coating composition can have an effect that is greater than the predicted additive effect of formulating each ingredient of the coating composition alone as if each component exerted its effect independently. For example, if the predicted additive effect is 70%, an actual effect of 140% is 70% greater than the predicted additive effect or is 1 fold greater than the predicted additive effect. The synergistic effect can be at least about 20, 50, 75, 90, 100, 150, 200 or 300% greater than the predicted additive effect. In some embodiments, the synergistic effect can be at least about 0.2, 0.5, 0.9, 1.1, 1.5, 1.7, 2, or 3 fold greater than the predicted additive effect.

In some embodiments, the synergistic effect of the coating compositions can also allow for reduced enzyme dosing amounts, leading to increased film stability and reduced costs of manufacture. Furthermore, the synergistic effect can allow for results that are not achievable through any other formulations. Therefore, proper identification, specification, and use of the coating compositions can allow for significant improvements in in-film enzyme activity.

### Liquid Components

In some embodiments, the coating composition comprises a liquid component. As used herein, the term “liquid component” shall be given its ordinary meaning and shall also refer to a chemical composition that is in a liquid state while comprised in a coating and/or film. Depending upon the ability of a liquid component to dissolve, partly dissolve, or unsuccessfully dissolve a coating component, the coating composition may comprise, a real solution, a colloidal solution and/or a dispersion, respectively, in some embodiments. In some embodiments, the addition of the liquid component improves a rheological property for ease of application, alters the period of time that thermoplastic film formation occurs, alters an optical property (e.g., color, gloss) of a film, alters a physical property of a coating (e.g., reduce flammability) and/or film (e.g., increase flexibility), or any combination thereof. In some embodiments, the liquid component comprises a volatile liquid that is partly or fully removed (e.g., evaporated) from the coating during film formation. In some embodiments, the volatile liquid comprises a volatile organic compound (“VOC”), water, or a combination thereof. In some embodiments, about 0% to about 100%, including all intermediate ranges and combinations thereof, of the liquid component is lost during film formation.

In some embodiments, a liquid component may comprise an azeotrope. As used herein, the term “azeotrope” shall be given its ordinary meaning and shall also refer to a solution of two or more liquid components at concentrations that produces a constant boiling point for the solution. In some embodiments, an azeotrope BP (“A-BP”) is the boiling point of an azeotrope. In some such embodiments, the boiling point (“BP”) of the majority component of an azeotrope is higher than the A-BP, and in still further embodiments, such an azeotrope evaporates from a coating faster than a similar coating that does not comprise the azeotrope. However, in some other embodiments, a coating comprising an azeotrope with a superior evaporation property may possess a lower flash point temperature, a lower explosion limit, a reduced coating flow, greater surface defect formation, or a combination thereof, relative to a similar coating that does not comprise the azeotrope. Alternatively, in some embodiments, an azeotrope may be selected for embodiments wherein a component's BP is increased. In some embodiments, a coating comprising such an azeotrope may have a relatively slower evaporation rate than a similar coating that does not comprise the azeotrope. It is contemplated that the greater the percentage of liquid component is an azeotrope, the greater the conference of an azeotrope's property to a coating.

In some embodiments, a chemically non-reactive (“inert”) liquid component may be selected that is inert relative to a particular chemical reaction to prevent an undesirable chemical reaction with other coating components. In some embodiments, an undesirable chemical reaction is a binder-liquid component reaction that is inhibitory to a desired binder-binder film-formation reaction.

In some embodiments, the liquid component comprises a liquid organic compound, an inorganic compound, water, or any combination thereof. In some embodiments, the liquid organic compound comprises a hydrocarbon. In certain aspects, the hydrocarbon comprises an aliphatic hydrocarbon, a cycloaliphatic hydrocarbon, a terpene, an aromatic hydrocarbon, or any combination thereof. In some embodiments, the liquid organic compound comprises an oxygenated solvent (e.g., an alcohol, an ester, a glycol ether, a ketone, an ether, or a combination thereof). In some embodiments, the liquid organic compound comprises a chlorinated hydrocarbon (e.g., methylene chloride, trichloromethane, tetrachloromethane, ethyl chloride, isopropyl chloride, 1,2-dichloroethane, 1,1,1-trichloroethane, trichloroethylene, 1,1,2,2-tetrachlorethane, 1,2-dichloroethylene, perchloroethylene, 1,2-dichloropropane, and/or chlorobenzene). In some embodiments, the liquid component comprises water. In some such embodiments, the liquid component comprising water further comprises methanol, ethanol, propanol, isopropyl alcohol, tert-butanol, ethylene glycol, methyl glycol, ethyl glycol, propyl glycol, butyl glycol, ethyl diglycol, methoxypropanol, methyldipropylene glycol, dioxane, tetrahydorfuran, acetone, diacetone alcohol, dimethylformamide, dimethyl sulfoxide, ethylbenzene, tetrachloroethylene, p-xylene, toluene, diisobutyl ketone, tricholorethylene, trimethylcyclohexanol, cyclohexyl acetate, dibutyl ether, trimethylcyclohexanone, 1,1,1-tricholoroethane, hexane, hexanol, isobutyl acetate, butyl acetate, isophorone, nitropropane, butyl glycol acetate, 2-nitropropane, methylene chloride, methyl isobutyl ketone, cyclohexanone, isopropyl acetate, methylbenzyl alcohol, cyclohexanol, nitroethane, methyl tert-butyl ether, ethyl acetate, diethyl ether, butanol, butyl glycolate, isobutanol, 2-butanol, propylene carbonate, ethyl glycol acetate, methyl acetate, methyl ethyl ketone, or any combination thereof.

In some embodiments, the composition coating comprises a water-borne coating, a solvent-borne coating, or a powder coating. As used herein, the term “solvent-borne coating” shall be given its ordinary meaning and shall also refer to a coating wherein 50% to 100%, the including all intermediate ranges and combinations thereof, of a coating's liquid component is not water. In some embodiments, the liquid component of a solvent-borne coating comprises an organic compound, an inorganic compound, or a combination thereof. In some embodiments, the coating composition is a water-borne coating (“water reducible coating”). As used herein, the term “water-borne coating” shall be given its ordinary meaning and shall also refer to a coating wherein a component such as a pigment, a binder, an additive, or a combination thereof are dispersed in water (e.g., wherein about 50% to about 100% of a coating's liquid component comprises water). In some such embodiments, the water component of a water-borne coating may function as a solvent, a thinner, a diluent, or a combination thereof. In certain embodiments, a water-borne coating may comprise an additional non-aqueous liquid component. In specific aspects, such an additional liquid component may function as a solvent, a thinner, a diluent, a plasticizer, or a combination thereof. An additional liquid component of a water-borne coating may comprise about 0% to about 49.999% of the liquid component. In some embodiments, an additional liquid component of a water-borne coating may be fully or partly miscible in water. In some embodiments, the coating composition is an aqueous dispersion.

In some embodiments, the water-borne coating is a latex coating. As used herein, the term “latex coating” shall be given its ordinary meaning and shall also refer to a water-borne coating wherein the binder may be dispersed in water. In many embodiments, a binder of a latex coating comprises a high molecular weight binder. In some embodiments, the latex coating comprises a thermoplastic coating. In some embodiments, film formation of the latex coating occurs by loss of the liquid component (e.g., via evaporation) and fusion of dispersed thermoplastic binder particles. In some embodiments, the latex coating further comprises a coalescing solvent that promotes fusion of the binder particles. In some embodiments, a film produced from a latex coating may be 1) more porous, 2) possesses a lower moisture resistance property, 3) may be less compact (e.g., thicker), and/or 4) a combination thereof, relative to a solvent-borne coating comprising similar non-volatile components.

### Binders

In some embodiments, the coating composition comprises a binder (“polymer,” “resin,” “film former”). As used herein, the term “binder” shall be given its ordinary meaning and shall also refer to a molecule capable of film formation. In some such embodiments, film formation refers to a physical and/or a chemical change of a binder in a coating, wherein the change converts the coating into a film. In some embodiments, a binder converts into a film through a polymerization reaction, wherein a first binder molecule covalently bonds with at least a second binder molecule to form a larger molecule (e.g., a “polymer”). In some embodiments, this process may be repeated a plurality of times, and the composition converts from a coating comprising a binder into a film comprising a polymer.

A binder may comprise, in some embodiments, a monomer, an oligomer, a polymer, or a combination thereof. In some embodiments, a monomer comprises a single unit of a chemical species that may undergo a polymerization reaction. However, In some embodiments, a binder itself may comprise a polymer, as such larger binder molecules are more suitable for formulation into a coating capable of both being easily applied to a surface and undergoing an additional polymerization reaction to produce a film. An oligomer for use in a coating composition typically comprises about 2 to about 25 polymerized monomers.

In some embodiments, the binder comprises a homopolymer (a polymer comprising monomers of the same chemical species), a copolymer (a polymer comprising monomers of at least two different chemical species), a linear polymer (an unbranched chain of monomers), a branched polymer (a branched (“forked”) chain of monomers), and/or a network (“cross-linked”) polymer (a branched polymer wherein at least one branch forms an interconnecting covalent bond with at least one additional polymer molecule).

In some embodiments, the binder comprises a thermoplastic binder, a thermosetting binder, or a combination thereof. In some embodiments, the binder comprises a thermoplastic binder. In some embodiments, film formation for a thermoplastic coating generally comprises a physical process, such as the loss of a volatile (e.g., liquid) component from the coating composition. In some such embodiments, as a volatile component is removed, a solid film can be produced through entanglement of the binder molecules. In some embodiments, a thermoplastic binder comprises a higher molecular mass than a comparable thermosetting binder. In some embodiments, the binder comprises a thermosetting binder that undergoes film formation by a chemical process (e.g., the cross-linking of a binder into a network polymer). In some embodiments, the thermosetting binder does not possess significant thermoplastic properties.

As used herein, the term “glass transition temperature” (T_{g}) shall be given its ordinary meaning and shall also refer to the temperature wherein the rate of increase of the volume of a binder and/or a film changes. Binders and films often do not convert from solid to liquid (“melt”) at a specific temperature (“Tₘ”), but rather possess a specific T_{g} wherein there is an increase in the rate of volume expansion with increasing temperature. At temperatures above the T_{g}, a binder and/or film becomes increasingly rubbery in texture until it becomes a viscous liquid. In some embodiments, a binder (e.g., a thermoplastic binder), may be selected by its T_{g}, which provides guidance to the temperature range of film formation, as well as thermal and/or heat resistance of a film. The lower the T_{g}, the “softer” the resin, and generally, the film produced from such a resin. A softer film typically possesses greater flexibility (e.g., crack resistance) and/or a poorer resistance to dirt accumulation than a harder film. In some embodiments, the binder has a glass transition temperature (T_{g}) between about 0° C. and 50° C. (e.g., 0°, 1°, 2°, 3°, 5°, 10°, 20°, 30°, 40°, 50°, and ranges in between).

In some embodiments, a coating comprises a low molecular weight polymer, a high molecular weight polymer, or a combination thereof. Examples of a low molecular weight polymer include, but are not limited to, an alkyd, an amino resin, a chlorinated rubber, an epoxide resin, an oleoresinous binder, a phenolic resin, a urethane, a polyester, a urethane oil, or a combination thereof. Examples of a high molecular weight polymer include, but are not limited to, a latex, a nitrocellulose, a non-aqueous dispersion polymer (“NAS”), a solution acrylic, a solution vinyl, or a combination thereof. Examples of a latex include, but are not limited to, an acrylic, a polyvinyl acetate (“PVA”), a styrene/butadiene, or a combination thereof.

In some embodiments, the binder comprises an oil-based binder, a polyester resin, a modified cellulose, a polyamide, an amino resin, a urethane binder, a phenolic resin, an epoxy resin, a polyhydroxyether binder, an acrylic resin, a polyvinyl binder, a rubber resin, a bituminous binder, a polysulfide binder, a silicone binder, an organic binder, or any combination thereof. In some embodiments, the binder comprises or is derived from vinyl monomers. In some embodiments, the binder comprises or is derived from styrene-butadiene copolymers, vinyl acetate copolymers, styrene acrylic copolymers, acrylic copolymers, or any combination thereof. In some embodiments, the binder comprises or is derived from Acronal PLUS 4670, Acronal EDGE 4750, Joncryl PRO 1522, or Joncryl PRO 1524. In some embodiments, the binder has a molecular weight of greater than about 50,000 g mol⁻¹. In some embodiments, the polyester resin comprises a hydroxy-terminated polyester, a carboxylic acid-terminated polyester, or a combination thereof. In some embodiments, the binder comprises a phenolic resin. In some embodiments, the binder comprises an oil-based binder selected from the group comprising an oil, an alkyd, an oleoresinous binder, a fatty acid epoxide ester, or a combination thereof.

### Pigments

In some embodiments, the pigment comprises a corrosion resistance pigment, a camouflage pigment, a color property pigment (a color pigment), an extender pigment a (filler), or any combination thereof.

In some embodiments, the pigment comprises a color property pigment. In some embodiments, the color property pigment comprises a black pigment, a brown pigment, a white pigment, a pearlescent pigment, a violet pigment, a blue pigment, a green pigment, a yellow pigment, an orange pigment, a red pigment, a metallic pigment, or a combination thereof. In some embodiments, the color property pigment includes, but is not limited to, aniline black, anthraquinone black, carbon black; copper carbonate, graphite, iron oxide, micaceous iron oxide, manganese dioxide, azo condensation, benzimidazolone, iron oxide, metal complex brown, antimony oxide, basic lead carbonate, lithopone, titanium dioxide, white lead, zinc oxide, zinc sulphide, titanium dioxide and ferric oxide covered mica, bismuth oxychloride crystal, dioxanine violet, carbazol Blue, carbazole Blue, cobalt blue, copper phthalocyanine, dioxanine Blue, indanthrone, phthalocyanin blue, Prussian blue, ultramarine, chrome green, chromium oxide green, halogenated copper phthalocyanine, hydrated chromium oxide, phthalocyanine green, anthrapyrimidine, arylamide yellow, barium chromate, benzimidazolone yellow, bismuth vanadate, cadmium sulfide yellow, complex inorganic color pigment, diarylide yellow, disazo condensation, flavanthrone, isoindoline, isoindolinone, lead chromate, nickel azo yellow, organic metal complex, quinophthalone, yellow iron oxide, yellow oxide, zinc chromate, perinone orange, pyrazolone orange, anthraquinone, benzimidazolone, BON arylamide, cadmium red, cadmium selenide, chrome red, dibromanthrone, diketopyrrolo-pyrrole pigment, disazo condensation pigment, lead molybdate, perylene, pyranthrone, quinacridone, quinophthalone, red iron oxide, red lead, toluidine red, tonor pigment, [3-naphthol red, aluminum flake, aluminum non-leafing, gold bronze flake, zinc dust, stainless steel flake, nickel flake, nickel powder, or any combination thereof.

In some embodiments, the coating composition comprises a colorant. In some aspects, the colorant comprises a pigment, a dye, a pH indicator, or a combination thereof. In specific aspects, the colorant comprises a pigment. In some embodiments, the color pigment comprises an organic pigment, an inorganic pigment, or any combination thereof. In some embodiments, the pigment comprises or is derived from an anionic pigment dispersion, a cationic pigment dispersion, or any combination thereof. In some embodiments, the organic pigment comprises azo chelate pigments, insoluble azo pigments, condensed azo pigments, phthalocyanine pigments, indigo pigments, perinone pigments, perylene pigments, dioxane pigments, quinacridone pigments, isoindolinone pigments, metal complex pigments, or any combination thereof. In some embodiments, the inorganic pigment comprises chrome yellow, yellow iron oxide, iron oxide red, carbon black and titanium dioxide; and extender pigments such as calcium carbonate, barium sulfate, clay, talc, or any combination thereof. In some embodiments, the pigment comprises TiO₂ (anatase), TiO₂ (rutile), clay (aluminum silicate), CaCO₃ (ground), CaCO₃ (precipitated), aluminum oxide, silicon dioxide, magnesium oxide, talc (magnesium silicate), baryte (barium sulfate), zinc oxide, zinc sulfite, sodium oxide, potassium oxide, or any combination thereof. In some embodiments, the TiO₂ pigment comprises or is derived from KRONOS® 2101, KRONOS® 2310, TI-PURE® R-900, TIONA® AT1, or any combination thereof. In some embodiments, the pigment comprises a titanium dioxide dispersion. In some embodiments, the pigment comprises a blend of metal oxides. In some embodiments, the pigment comprises a blend of metal oxides selected from the group consisting of MINEX, CELITE, ATOMITE, or any combination thereof. In some embodiments, the pigment comprises two or more of oxides of silicon, aluminum, sodium and potassium.

In some embodiments, the pigment comprises one or more extender pigments (fillers). In some embodiments, the filler comprises a solid (e.g., an insoluble) additive incorporated into polymeric material (e.g., a reinforced polymeric material, a composite). In some embodiments, a filler alters a property such as enhance hardness, enhances creep resistance, increases impact resistance, increases the heat deflection temperature, alters (e.g., increase) density of the material, reduces the shrinkage of the material, alters electrical conductivity, alters thermal conductivity, or any combination thereof. In some embodiments, a filler can bond (e.g., covalently attach, ionically attach) to a component (e.g., a polymer) of a coating composition without an agent such as a coupling agent or a crosslinking agent.

In some embodiments, the extender pigment comprises a clay, TiO₂, CaCO₃, or any combination thereof. In some embodiments, the extender pigment comprises attapulgite clay, kaolin clay, nepheline syenite, (25% nepheline, 55% sodium feldspar, and 20% potassium feldspar), feldspar (an aluminosilicate), diatomaceous earth, calcined diatomaceous earth, talc (hydrated magnesium silicate), aluminosilicates, silica (silicon dioxide), alumina (aluminum oxide), alumina trihydrate (ATM), mica (hydrous aluminum potassium silicate), pyrophyllite (aluminum silicate hydroxide), perlite, baryte (barium sulfate), wollastonite (calcium metasilicate), or any combination thereof. In some embodiments, the extender pigment comprises Mg3Si4010(OH)₂, BaSO₄, (NaK)Al₂(AlSi₃)O₁₀(OH)₂, CaCO₃, Al₂Si₂O₅(OH)₄, SiO2, KAl₂(AlSi₃O₁₀)(OH)₂, or any combination thereof. In some embodiments, the extender pigment comprises SiO2. In some aspects, the extender pigment comprises a barium sulphate, a calcium carbonate, a kaolin, a calcium sulphate, a silicate, a silica, an alumina trihydrate, or a combination thereof. In some embodiments, the filler provides desired performance relating to dimensional stability of the coating composition.

In some embodiments, metal fillers are provided, including, but not limited to, a metal powder, a metal fiber, a metal coated microsphere, a metal coated fiber (e.g., an organic fiber coated with a metal), or any combination thereof. In some embodiments a filler may comprise a particular material, a fibrous filler such as a synthetic fiber (e.g., a polyamide fiber), a natural fiber glass (e.g., a cotton), a carbon/graphite fiber, a ceramic fiber (e.g., a metal oxide fiber, a silicone whisker), or any combination thereof. In other embodiments, the filler comprises an organic filler (e.g., a cellulosic filler, a lignin filler, a synthetic organic fiber, an animal filler, a carbon filler, a reclaimed filler), an inorganic filler, or any combination thereof.

In some embodiments, the filler comprises an inorganic filler, including but not limited to, an aluminum trihydrate, a barium ferrite, a barite filler (e.g., a lead sulfate, a barium sulfate, a strontium sulfate, a barium chromate sulfate), a boron filler (e.g., a boron fiber, a boron filament, a boron whisker), a calcium carbonate filler (e.g., a precipitated calcium carbonate, a ground calcium carbonate, a whiting/chalk, a limestone), a glass filler, a metal filler (e.g., a metal, a metal oxide, a fiber, a filament, a whisker), an inorganic polymeric filler, a silica filler (e.g., a silica mineral, a silica synthetic filler), a silicate (e.g., a silicate mineral, a silicate synthetic filler), or any combination thereof. Examples of a glass filler include a glass sphere (e.g., a solid glass sphere, a hollow glass sphere), a glass flake, a glass fiber (e.g., a fabric, a filament, a mat, a milled fiber, a roving, a woven roving, a yarn), or any combination thereof. In some embodiments, a metal (e.g., a metal alloy) is used as a filler (e.g., a fiber, a filament), a metallized surface deposit, and/or an adherent for attachment of an adhesive, a sealant, a surface treatment, or any combination thereof. Metals that may be employed as fillers, in some such embodiments, include, but are not limited to, an aluminum, a beryllium, a copper (e.g., a bronze, a brass), a cadmium, a chromium, a gold, an iron (e.g., a stainless steel), a germanium, a lead, a magnesium, a molybdenum, a nickel (e.g., a nickel phosphorus alloy), a silver, a tin, a titanium, a thorium, a tungsten, a zinc, a palladium, a platinum, a zirconium, a uranium, or any combination thereof. In some embodiments, metal oxide fillers include, but are not limited to, a titanium oxide (e.g., a titanium dioxide), a zinc oxide, a magnesium oxide, an aluminum oxide, or any combination thereof. In some embodiments, the coating composition comprises a silica mineral filler selected from the group comprising a diatomaceous earth, a quartz, a sand, a tripoli, or any combination thereof. Synthetic silica fillers, such as a silica aerogel, a ground silica, a pyrogenic silica, a wet process silica, a silicon whisker (e.g., a silicon nitride, a silicon carbide), or any combination thereof, are also provided in some embodiments. Silicate mineral fillers, such as, for example, an actinolite (e.g., a kaolinite/china clay, a mica, a talc, a Wollastanite), an asbestos, an amosite, an anthophyllite, a crocidolite, a chrysolite, a tremollite, or any combination thereof, are also provided in some embodiments.

The pigment volume concentration is the volume of pigment in the total volume solids of a dry film. The volume solids is the fractional volume of binder and pigment in the total volume of a coating. A related calculation to the PVC that is specifically contemplated is the critical pigment volume concentration (“CPVC”); this is the formulation of pigment and binder wherein the coating comprises the minimum amount of binder to fill the voids between the pigment particles. In some embodiments, a pigment to binder concentration that exceeds the CVPC threshold produces a coating with empty spaces wherein gas (e.g., air, evaporated liquid component), may be trapped. Standard procedures for determining CPVC are known to those of ordinary skill in the art [see, for example, in “ASTM Book of Standards, Volume 06.01, Paint-Tests for Chemical, Physical, and Optical Properties; Appearance,” D1483-95, D281-95, and D6336-98, 2002; and in “Paint and Coating Testing Manual, Fourteenth Edition of the Gardner-Sward Handbook,” (Koleske, J. V. Ed.), pp. 252-258, 1995]. In some embodiments, the PVC is critical PVC. In some embodiments, the PVC is below CPVC. In some embodiments, the PVC is about 0.001% to about 70% (e.g. 0.001%, 0.005%, 0.01%, 0.03%, 0.05%, 0.07%, 0.09%, 0.1%, 0.11%, 0.13%, 0.15%, 0.17%, 0.19%, 0.2%, 0.5%, 0.7%, 1%, 2%, 5%, 10%, 20%, 30%, 40%, 50%, 60%, 70% and ranges in between). In some embodiments, the PVC is about 0% to about 10%, is about 10% to about 20%, is about 20% to about 30%, is about 30% to about 40%, is about 40% to about 50%, is about 50% to about 60%, is about 60% to about 70%, is about 70% to about 80%, and all ranges in between. There are provided, in some embodiments, methods of maintaining the in-film activity of an enzyme in a coating composition by increasing the PVC. In some such embodiments, the method comprises adding one or more enzymes (e.g., a mannanase, a cellulase, an amylase, a lipase, a protease, a laccase, or any combination thereof) to a coating composition wherein the PVC is at least about 20%. In some embodiments, the in-film enzyme activity increased by greater than 2% (e.g., 2%, 3%, 4%, 5%, 6%, 7%, 8%, 9%, 10%, 11%, 12%, 13%, 14%, 15%, 16%, 17%, 18%, 19%, 20%, 25%, 30%, 40%, 50%, 75%, 100%, or higher and overlapping ranges therein) as compared to a coating composition with a PVC of less than about 20%. There are also provided, in some embodiments, methods of maintaining urease in-film activity, wherein urease in-film activity is increased by decreasing the PVC. In some such embodiments, the method comprises adding urease to a coating composition wherein the PVC is less than about 20%. In some embodiments, the in-film urease activity increased by at least about 2% (e.g., 2%, 3%, 4%, 5%, 6%, 7%, 8%, 9%, 10%, 11%, 12%, 13%, 14%, 15%, 16%, 17%, 18%, 19%, 20%, 25%, 30%, 40%, 50%, 75%, 100%, or higher and overlapping ranges therein) as compared to a coating composition with a PVC of greater than about 20%.

### Dispersants and Wetting Agents

In some embodiments, one or more types of a particulate matter (e.g., a pigment) may be incorporated into the coating compositions disclosed herein. In some embodiments, physical force and/or chemical additives are employed to promote dispersion of a particulate matter in a coating composition for purposes such as coating homogeneity and ease of application. Depending upon whether such an additive may be admixed earlier or later in a coating composition, such an additive may be known as a wetting agent or a dispersant, respectively, though such an additive may have dual classification. A wetting agent and/or a dispersant often may be used, in some embodiments, to reduce the particulate matter grinding time during coating preparation, improve wetting of a particulate matter, improve dispersion of a particulate matter, improve gloss, improve leveling, reduce flooding, reduce floating, reduce viscosity, reduce thixotropy, or any combination thereof.

In some embodiments, the coating composition comprises one or more dispersants (“dispersing additive,” “deflocculant,” “antisettling agent”). As used herein, the term “dispersant” shall be given its ordinary meaning and shall also refer to a composition added to promote continuing dispersal of a particulate matter. In some embodiments, a dispersant may be added to a coating composition to reduce or prevent flocculation (a process wherein a plurality of primary particles that have been previously dispersed form an agglomerate). In some embodiments, a dispersant may be added to a coating composition to prevent sedimentation of a particulate matter. In some embodiments, the addition of a dispersant maintains the dispersal of a particulate matter comprised within a coating composition. In some embodiments, a dispersant comprises a compound comprising a phosphate. In some aspects, a dispersant may comprise a particulate material. A dispersant may comprise a modified montmorillonite in some embodiments. In some embodiments, the dispersant stabilizes finely dispersed pigment and filler particles. In some embodiments, the dispersant include polymeric, oligomeric and surfactant-based dispersing agents including those sold under the Dispex® and Efka® marks (commercially available from BASF Corporation). Other exemplary dispersants can include sodium polyacrylates in aqueous solution such as those sold under the DARVAN trademark.

In some embodiments, preparation of a coating comprising a particulate material often comprises a step wherein the particulate material may be dispersed in an additional coating component. An example of this type of dispersion step may be the dispersion of a pigment into a combination of a liquid component and a binder to form a material known as a millbase. In some embodiments, the coating composition comprises one or more wetting agents. As used herein, the term “wetting agent” shall be given its ordinary meaning and shall also refer to a composition added to promote dispersion of a particulate material during coating preparation. In some embodiments, a wetting agent comprises a molecule comprising a polar region and a nonpolar region (e.g., an ethylene oxide molecule comprising a hydrophobic moiety). In some such embodiments, the wetting agent acts by reducing interfacial tension between a liquid component and particulate matter. In some embodiments, a wetting agent comprises a surfactant.

### Plasticizers

In some embodiments, one or more plasticizers are added to the coating compositions provided herein. In some embodiments, the plasticizer confers one or more of the following to the coating composition: enhances a flow property of a coating, lowers a film-forming temperature range, enhances the adhesion property of a coating and/or a film, enhances the flexibility property of a film, lowers the glass transition temperature (T_{g}), improves film toughness, enhances film heat resistance, enhances film impact resistance, and/or enhances UV resistance. In some embodiments, a plasticizer may be selected for water resistance (e.g., hydrolysis resistance, inertness toward water) such as a bisphenoxyethylformal. In some embodiments, the plasticizer reduces the glass transition temperature (T_{g}) of the compositions below that of the drying temperature to allow for good film formation. In some embodiments, the plasticizer comprises an adipate, an azelate, a citrate, a chlorinated plasticizer, an epoxide, a phosphate, a sebacate, a phthalate, a polyester, a trimellitate, or any combination thereof. In some embodiments, the plasticizer is selected from the group comprising diethylene glycol dibenzoate, dipropylene glycol dibenzoate, tripropylene glycol dibenzoate, butyl benzyl phthalate, a phthalate-based plasticizer, or any combination thereof.

### Coalescing Agents

In some embodiments, the coating composition comprises one or more coalescing agents to aid in-film formation during drying. In some embodiments, the coalescing agent promotes the fusion of the binder particles. In some embodiments, the coalescing agent is selected from the group comprising ethylene glycol monomethyl ether, ethylene glycol monobutyl ether, ethylene glycol monoethyl ether acetate, ethylene glycol monobutyl ether acetate, diethylene glycol monobutyl ether, diethylene glycol monoethyl ether acetate, dipropylene glycol monomethyl ether, propylene glycol n-butyl ether, dipropylene glycol n-butyl ether (DPnB), 2,2,4-trimethyl-1,3-pentanediol monoisobutyrate (Texanol), and any combination thereof. In some embodiments, the coalescing agent is present in an amount of at least about 6.0 wt % (e.g., 6, 7, 8, 9, 10, 11, 12, 13, 14, 15, 16, 17, 18, 19, 20, or higher and overlapping ranges therein), wherein in-film enzyme activity increased by at least about 5% compared to a coating composition comprising the coalescing agents in an amount of less about 6.0 wt %. In some embodiments, the coating composition comprises a humectant. In some embodiments, the humectant is selected from the group comprising ethylene glycol, propylene glycol, diethylene glycol, or any combination thereof.

### Defoamers

In some embodiments, the coating composition comprises one or more defoamers (“antifoaming agent,” “antifoaming additive”). As used herein, the term “defoamer” shall be given its ordinary meaning and shall also refer to a composition that releases a gas (e.g., air) and/or reduces foaming in a coating during production, application, film formation, or a combination thereof. A coating composition sometimes comprises a gas capable of forming a bubble (“foam”) that may undesirably alter a physical and/or an aesthetic property. Gas incorporation into a coating composition may be a side effect of coating preparation processes. Often, a wetting agent and/or a dispersant used in a coating may promote creation or retention of foam voids as a side effect. In some embodiments, defoamers minimize frothing during mixing and/or application of the formulation. In some embodiments, the defoamer is selected from the group comprising mineral oils, silicone oils, silica-based defoamers, or any combination thereof. In some embodiments, the silicoine oil is selected from the group comprising polysiloxanes, polydimethylsiloxanes, polyether modified polysiloxanes, or any combination thereof. Exemplary defoamers include BYK®-035, available from BYK USA Inc., the TEGO® series of defoamers, available from Evonik Industries, the DREWPLUS® series of defoamers, available from Ashland Inc., and FOAMASTER® NXZ, available from BASF Corporation.

### Rheoloqy Modifiers

In some embodiments, one or more rheology modifiers (e.g., thickeners) are added to the coating composition. As used herein, the term “rheology modifier” shall be given its ordinary meaning and shall also refer to a composition that alters (e.g., increases, decreases, maintains) a rheological property of a coating. Examples of rheological properties of the coating composition modified by the rheology modifiers disclosed herein include, but are not limited to, viscosity (a measure of a fluid's resistance to flow (e.g., a shear force)), brushability (the ease a coating may be applied using an applicator (e.g., a brush)), leveling (the ability of a coating to flow into and fill uneven areas of coating thickness (e.g., brush marks) after application to a surface and before sufficient film formation to end such flow), sagging (the gravitationally induced downward flow of a coating after application to a surface and before sufficient film formation to end such flow), or any combination thereof. A rheology modifier may be added to alter and/or maintain a rheology property within a desired range post-formulation, during application, post-application, or a combination thereof. In some embodiments, the viscosity of the coating composition varies during preparation (“mixing”), during storage (e.g., in a container), during application, and/or upon a surface. In some embodiments, the viscosity of a coating composition post-preparation and/or application may be between about 0.05 P to about 3000 P (e.g., 0.05, 0.1, 0.2, 0.3, 0.4, 0.5, 0.6, 0.7, 0.8, 0.9, 1.0, 2, 5, 10, 20, 50, 100, 200, 300, 400, 500, 1000, 2000, 3000, and ranges in between).

In some embodiments, the rheology modifier is selected from the group comprising hydrophobically modified ethylene oxide urethane (HEUR) polymers, hydrophobically modified alkali soluble emulsion (HASE) polymers, hydrophobically modified hydroxyethyl celluloses (HMHECs), hydrophobically modified polyacrylamide, or any combination thereof. In some embodiments, the HASE polymers comprise or are derived from homopolymers of (meth)acrylic acid, copolymers of (meth)acrylic acid, copolymers of (meth)acrylate esters, maleic acid modified with hydrophobic vinyl monomers, or any combination thereof. In some embodiments, HMHECs include hydroxyethyl cellulose modified with hydrophobic alkyl chains. In some embodiments, hydrophobically modified polyacrylamides include copolymers of acrylamide with acrylamide modified with hydrophobic alkyl chains (N-alkyl acrylamide). In some embodiments, the rheology modifier comprises or is derived from acrylic copolymer dispersions, urethanes, hydroxyethyl cellulose, guar gum, jaguar, carrageenan, xanthan, acetan, konjac, mannan, xyloglucan, urethanes, or any combination thereof. Other suitable thickeners that can be used in the coating composition can include acrylic copolymer dispersions sold under the STEROCOLL™ and LATEKOLL™ trademarks from BASF Corporation, Florham Park, N.J. and urethanes thickeners sold under the RHEOVIS™ trademark (e.g., Rheovis PU 1214). In some embodiments, the thickeners are added to the composition formulation as an aqueous dispersion or emulsion; in other embodiments, the thickeners are added as a solid powder. Additional rheology modifiers can be included in the coating compositions described herein to, for example, control the froth properties relating to penetration of a formulation and weight control of a formulation. In some such embodiments, surfactant types and levels can influence the rheology of a formulation to determine such properties.

### Neutralizers

In some embodiments, the pH of the coating composition is maintained within a certain range by the addition of a neutralizer (buffer). In some embodiments, the neutralizer may be selected to help maintain the pH of a coating composition to promote an enzyme's activity. For example, in certain aspects, a basic pH may improve the function of an enzyme, such as, for example, a lipolytic enzyme. For example, in such embodiments, an acid released by a lipolytic enzyme's activity may detrimentally alter the local pH relative to optimum conditions for activity, and a buffer may reduce this effect. Alternatively, the neutralizer may be selected based on enzymes within the coating composition that function at neutral and/or basic pH, or to effect the function of other components of the coating composition, such as, for example, the curing process. In some embodiments, the neutralizer is selected from the group comprising sodium hydroxide, potassium hydroxide, amino alcohols, monoethanolamine (MEA), diethanolamine (DEA), 2-(2-aminoethoxy)ethanol, diisopropanolamine (DIPA), I-amino-2-propanol (AMP), ammonia, or any combination thereof. In some embodiments, the pH of the coating composition can be from 3 to 11 (e.g., from 3 to 7, from 7 to 11, from 3 to 5, from 5 to 7, from 4 to 9, or from 5 to 8). In some embodiments, the pH of the coating composition before it is applied to the surface is from about 3 to about 11. In some embodiments, the pH of the coating composition before it is applied to the surface is from about 5 to about 9.

### Dyes

In some embodiments, the coating composition comprises one or more dyes. As used herein, the term “dye” shall be given its ordinary meaning and shall also refer to a composition that is soluble in the other component(s) of a coating composition, and further confers a color property to the coating. In some embodiments, the dye is selected from the group comprising basic dyes, acid dyes, anionic direct dyes, cationic direct dyes, or any combination thereof.

### Biocides

In some embodiments, the coating composition further comprises a biocide. In some embodiments, the biocide inhibits the growth of bacteria and/or other microbes in the coating composition. Depending on the embodiment, the biocide is a microbiocide, a bactericide, a fungicide, an algaecide, a mildewcide, a molluskicide, a viricide, or a combination thereof. In some embodiments, the biocide comprises 2-[(hydroxymethyl)amino]ethanol, 2-[(hydroxymethyl) amino]2-methyl-1-propanol, o-phenylphenol, sodium salt, 1,2-benzisothiazolin-3-one, 2-methyl-4-isothiazolin-3-one (MIT), 5-chloro-2-methyl-4-isothiazolin-3-one (CIT), 2-octyl-4-isothiazolin-3-one (01T), 4,5-dichloro-2-n-octyl-3-isothiazolone, as well as acceptable salts and combinations thereof. Mildewcides include, but are not limited to, 2-(thiocyanomethylthio) benzothiazole, 3-iodo-2-propynyl butyl carbamate, 2,4,5,6-tetrachloroisophthalonitrile, 2-(4-thiazolyl)benzimidazole, 2-N-octyl-4-isothiazolin-3-one, diiodomethyl p-tolyl sulfone, as well as acceptable salts and combinations thereof. In some embodiments, the coating composition comprises 1,2-benzisothiazolin-3-one or a salt thereof (e.g., PROXEL® BD20, commercially available from Arch Chemicals, Inc.). In some embodiments, the biocide is applied as a film to the formulation. In some embodiments, the film-forming biocide is Zinc Omadine®.

### EXAMPLES

### Example 1: Optimization of Enzyme Extraction from Liquid Paint and Dry Film

In this example, enzyme extraction methodology and an optimal protocol were developed for maximal recovery of enzyme activity from liquid paint and dry film. The following extraction factors were tested: pH: (7.5, 8.5, and 10.0); detergent (Triton X-100) concentration (at 0%, 0.25%, 0.5%, and 1.0%); salt concentration (0, 100, 500 and mM); BSA concentration (0, 0.1%, and 1.0%); temperature (RT, 40° C., 60° C., and 80° C.); and incubation time: (15, 30, 60, and 120 minutes). Table 1 depicts the paint samples (wet paint and dry film) employed in the extraction optimization studies, which vary with regards to both PVC levels and filler chemistry. Paint samples were loaded with cellulase/mannanase Pyrolase HT® at the indicated concentrations.

TABLE 1
PAINT SAMPLES USED FOR EXTRACTION OPTIMIZATION

| | Enzyme | | | | |
|---|---|---|---|---|---|
| Sample | Loading | Activity | | | Filler |
| # | (wt %) | (U/g) | PVC | Filler Chemistry | Product |
| 4A-3 | 0.19% | 47.8 | 40 | Mg₃Si₄O₁₀(OH)₂ | Mistron 400C |
| 4B-3 | 0.19% | 47.8 | 20 | Mg₃Si₄O₁₀(OH)₂ | Mistron 400C |
| 8A-3 | 0.19% | 47.8 | 40 | BaSO₄ | Barimite 200 |
| 8B-3 | 0.19% | 47.8 | 20 | BaSO₄ | Barimite 200 |

### Methods

For sample extraction, 50 mg of wet paint or film was weighed out and added to 500 μL of buffer (10× extraction ratio). The sample was agitated by shaking for 1 hour at the designated time and temperature. Liquid control samples were diluted and also treated in the same way. Samples were centrifuged and the supernatant was further analyzed by enzyme activity assay and protein quantification. The enzyme substrate employed was Resorufin Cellobioside (0.1 mM in reaction). All the extracted samples were diluted 50× for the assay with a dilution buffer comprising 50 mM MES buffer, pH 6, and 0.5% Triton X-100. The assay was performed at temperature of 25° C., and the enzyme activity was detected with an excitation wavelength of 550 nm and an emission wavelength of 590 nm. Enzyme quantity was determined by SDS-PAGE. Relative specific activity was calculated by the ratio of enzyme activity:quantity.

### Results and Conclusions of Enzyme Extraction Studies

For enzyme extraction from dry film samples, a high pH and high temperature were found to improve extraction, and higher detergent (Triton X-100) concentration also improved extraction. It was found that the use of NaCl and BSA did not increase enzyme extraction from dry film. While it was discovered that higher temperature extracts enzyme faster from film, it also leads to loss of activity over time. For enzyme extraction from wet paint samples, it was discovered that full enzyme activity was easily extracted and recovered in very short extraction time. pH, temperature, use of detergent (Triton X100), NaCl and BSA had little effect. Additionally, it was found that higher temperatures and longer extraction times resulted in lower recovered specific activity. The studies provide proof of concept that enzymes directly embedded in wet paint retain their activity, and further that they remain active following subsequent extraction from film.

Based on these investigations, the following optimized extraction conditions (for “harsh” extraction) were derived: 1) an extraction solution comprising 50 mM CAPS Buffer, pH 10, 0.5% Triton; 2) an extraction ratio of 10× (500 μl extraction solution added to 50 mg of wet paint or dry film); 3) an incubation time of 30 minutes shaking; and 4) an incubation temperature of 60° C. for dry film and room temperature for wet paint. The extraction mixture is centrifuged at 30,000 g for 5 minutes, and supernatant is then analyzed for enzyme activity and protein quantity.

Procedures for Enzyme Extraction from Dry Film (“Harsh Extraction”) and Enzyme Analysis from the Extract

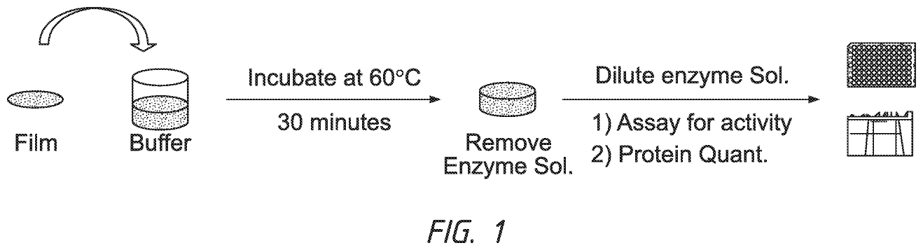

Based on the foregoing investigations the following “harsh” enzyme extraction protocol (with elevated temperature & pH) was developed. Following incubation at 60° C. for 30 minutes in 50 mM CAPS buffer (with 0.5% Triton-X100, pH 10), the enzyme solution is removed, diluted, and assayed for activity and protein quantification. Activity is determined using Resorufin Cellobioside as substrate (in 50 mM MES Buffer with 0.25% Triton-X100, pH 6 at room temperature) while protein quantification is performed by SDS-PAGE. FIG. 1 depicts a schematic representation of a procedure for “harsh” enzyme extraction from dry film according to several embodiments disclosed herein.

### Example 2: Use of Paint Samples with Different Ingredient Matrices to Elucidate the Impact of Paint Formulations on Enzyme Activity Extraction

In this example, different paint formulations (e.g. PVC, fillers, pH, latex chemistry, additive chemistry) were used to understand the mechanism of enzyme recovery loss and identify the components compatible or not compatible with enzyme in wet paint and dry paint films. Paint samples were loaded with cellulase/mannanase Pyrolase HT® at the indicated concentrations.

### Group 1

Table 2 depicts the Group 1 samples used to understand the impact of paint ingredients on enzyme activity recovery. The “Set 1” and “Set 3” samples were loaded with low and high levels of enzymes, respectively. The listed enzyme loading % and activity in Table 2 are targets in wet paint samples; these target levels in corresponding dry film samples are expected to be doubled due to drying.

TABLE 2
PAINT FORMULATION - GROUP 1 PAINT SAMPLES

| | Set 1 | | Set 3 | | | | |
|---|---|---|---|---|---|---|---|
| | Enzyme | | Enzyme | | Paint Formulation | | |
| Sample | loading | Activity | loading | Activity | | | Filler |
| # | (wt %) | (u/g) | (wt %) | (u/g) | PVC | Filler Chemistry | Product |
| OA | 0.0000% | 0.0 | | | 40 | (NaK)Al2(AlSi3)O10(OH)2 | Minex 4 |
| OB | | | | | 20 | | |
| 1A | 0.0036% | 0.90 U/g | 0.19% | 47.8 U/g | 40 | CaCO3 | Duramite |
| 1B | | | | | 20 | | |
| 2A | | | | | 40 | Al2Si2O5(OH)4 | ASP 172 |
| 2B | | | | | 20 | | |
| 3A | | | | | 40 | Al2Si2O5(OH)4 | Mattex Pro |
| 3B | | | | | 20 | | |
| 4A | | | | | 40 | Mg3Si2O5(OH)2 | Mistron 400c |
| 4B | | | | | 20 | | |
| 5A | | | | | 40 | SiO2 | Celatom |
| 5B | | | | | 20 | | |
| 6A | | | | | 40 | KAl2(AlSi3))10(OH)2 | Mica WG 325 |
| 6B | | | | | 20 | | |
| 7A | | | | | 40 | (NaK)Al2(AlSi3)O10(OH)2 | Minex 4 |
| 7B | | | | | 20 | | |
| 8A | | | | | 40 | BaSO4 | Barimite 200 |
| 8B | | | | | 20 | | |

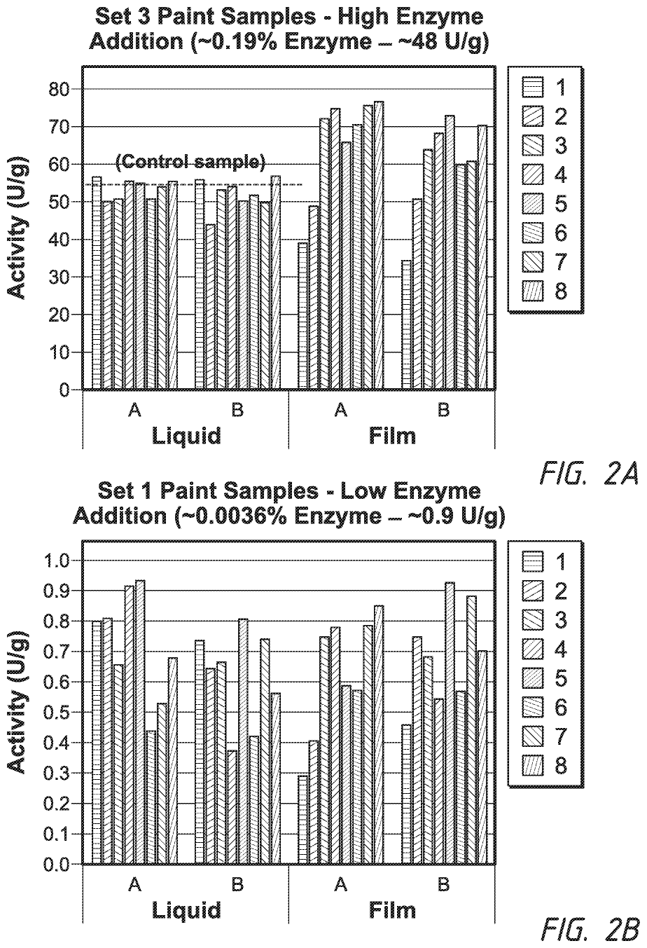

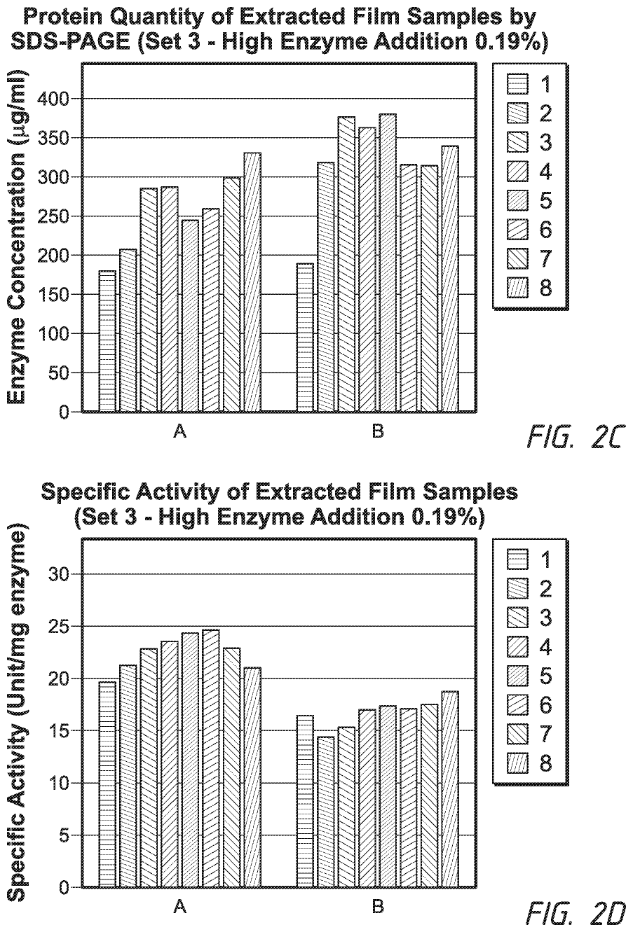

Wet paint samples with high enzyme loading (Set 3) showed near complete enzyme recovery. On the other hand, dry film samples with high enzyme addition showed overall lower recovery than wet paint; however, still more than 50% recovery was observed for most samples in Set 3 (FIG. 2A). Recovery from samples with low enzyme addition (Set 1) showed more variations among samples, with lower recovery found in the dry film samples. (FIG. 2B). PVC level did not appear to have any obvious effect of enzyme activity recovery. Interestingly, filler chemistry impacted enzyme extractability of dry film samples, as CaCO₃ (Duramite)—Sample 1 and Al2Si2O5(OH)₄ (ASP172)—Sample 2 exhibited the lowest recovery.

FIG. 2C shows the protein quantity of extracted Set 3 film samples and FIG. 2D shows the specific activity (enzyme activity/enzyme quantitation) of these samples. There was no obvious difference in specific activity observed among the samples, with values found to be very close to the control enzyme sample, indicating the extracted enzyme from different film samples is as active as the control enzyme. The difference between sample sets “A” and “B” (pigment volume concentration (PVC) of 40% and 20%, respectively) is likely due to experimental variation.

### Group 2

A second group of paint formulation—Group 2—is depicted in Table 3. The Group 2 paint samples include 17 different formulations: 10 samples with enzyme loading (0.1% in wet paint and −0.2% Enzyme in dry film) and 7 control samples with no enzyme addition. The v1-v3 samples are similar to industrial coating formulations: they have a low PVC level and contain different Joncryl latex that is rigid and requires coalescing agents (such as DPnB and Texanol) for film formation. The v6-v7 Samples are similar to the Group 1 paint samples and comprise CaCO₃ (Duramite) filler, different VOC levels, and different neutralizing agent types (NaOH vs NH₃) and concentrations.

TABLE 3
PAINT FORMULATION - GROUP 2 PAINT SAMPLES

| Sample | 2 | 4 | 5 | 7 | 8 | 9 |
|---|---|---|---|---|---|---|
| Name | v1_E230 | v1_E230 | v1_E200 | v1_E230 | v1_E200 | v1_E100 |
| Latex | Joncryl 537 | Joncryl 1522 | Joncryl 1522 | Joncryl 1524 | Joncryl 1524 | Joncryl 1524 |
| Neutralizer | | | | | | |
| Water | 68.6 | 68.6 | 68.6 | 68.6 | 68.6 | 68.6 |
| Neutralizer | | | | | | |
| Dispex CX 4230 | 2.0 | 1.9 | 1.9 | 1.9 | 1.9 | 1.9 |
| Dispex Ultra FA 4416 | 0.5 | 0.4 | 0.4 | 0.4 | 0.4 | 0.4 |
| FoamStar ST 2446 | 2.4 | 2.4 | 2.4 | 2.4 | 2.4 | 2.4 |
| Ti-Pure R-900 | 140.1 | 140.1 | 140.1 | 140.1 | 140.1 | 140.1 |
| Grind for 20 min | | | | | | |
| Water | 18.97 | 18.97 | 18.97 | 18.97 | 18.97 | 18.97 |
| Dipropylene glycol n-butyl | 60 | 60 | 50 | 60 | 50 | 22 |
| ether (DPnB) | | | | | | |
| Texanol | 30 | 30 | 25 | 30 | 25 | 11 |
| Hydropalat WE 3322 | 2 | 2 | 2 | 2 | 2 | 2 |
| Binder | 640.42 | 640.42 | 640.42 | 640.42 | 640.42 | 640.42 |
| Rheovis PU 1191 | 0.5 | 0.5 | 0.5 | 0.5 | 0.5 | 0.5 |
| Total | 965.5 | 965.3 | 950.3 | 965.3 | 950.3 | 908.3 |
| Pyrolase HT (4% cellulase) | 24.1 | 24.1 | 23.8 | 24.1 | 23.8 | 22.7 |
| Pyrolase HT (4% cellulase) | 0.1% | 0.1% | 0.1% | 0.1% | 0.1% | 0.1% |
| % active | | | | | | |
| VOC | 230 | 230 | 200 | 230 | 200 | 100 |
| PVC | 12 | 12 | 12 | 12 | 12 | 12 |

| Sample | 14 | 15 | 16 | 17 |
|---|---|---|---|---|
| Name | V6_E40 | V6_E20 | V7_E40 | V7_E20 |
| Latex | AN4750 | AN4750 | MXK17601-603 | MXK17601-603 |
| Neutralizer | Ammonia (29%) | Ammonia (29%) | NaOH (29%) | NaOH (29%) |
| Water | 90.4 | 61.5 | 90.4 | 61.5 |
| Neutralizer | 0.75 | 0.86 | 0.75 | 0.86 |
| Dispex CX 4340 | 2.00 | 2.30 | 2.00 | 2.30 |
| FoamStar ST 2420 | 1.00 | 1.15 | 1.00 | 1.15 |
| Proxel DB 20 | 1.50 | 1.73 | 1.50 | 1.73 |
| Kronos 2310 | 100.0 | 48.8 | 100.0 | 48.8 |
| Duramite | 100.0 | 48.8 | 100.0 | 48.8 |
| Attagel 50 | 2.00 | 2.30 | 2.00 | 2.30 |
| Total | 297.6 | 137.5 | 397.6 | 167.5 |
| Mix for 10-15 min, then add: | | | | |
| Water | 37.5 | 287 | 37.5 | 28.7 |
| Foamstar ST 2420 | 1.00 | 1.15 | 1.00 | 1.15 |
| Hydropalat WE 3320 | 1.00 | 1.15 | 1.00 | 1.15 |
| Loxanol CA 5320 | 4.50 | 5.17 | 4.50 | 5.17 |
| Binder | 212.5 | 282.5 | 212.5 | 282.5 |
| Rheovis PE 1331 | 6.25 | 7.8 | 6.25 | 7.18 |
| Rheovis PU 1191 | 0.50 | 0.58 | 0.50 | 0.58 |
| Total grams (eguiv. to lbs/100 gal) | 560.9 | 493.9 | 560.9 | 493.9 |
| Pyrolase HT (4% cellulase) | 14.02 | 12.35 | 14.02 | 12.35 |
| Pyrolase HT (4% cellulase) | 0.1% | 0.1% | 0.1% | 0.1% |
| % active | | | | |
| Viscosity target | 95-100 | 95-100 | 95-100 | 95-100 |
| Viscosity target | 1.0-1.5 | 1.0-1.5 | 1.0-1.5 | 1.0-1.5 |
| Volume Solids | 39% | 39% | 39% | 39% |
| PVC | 40% | 20% | 40% | 20% |

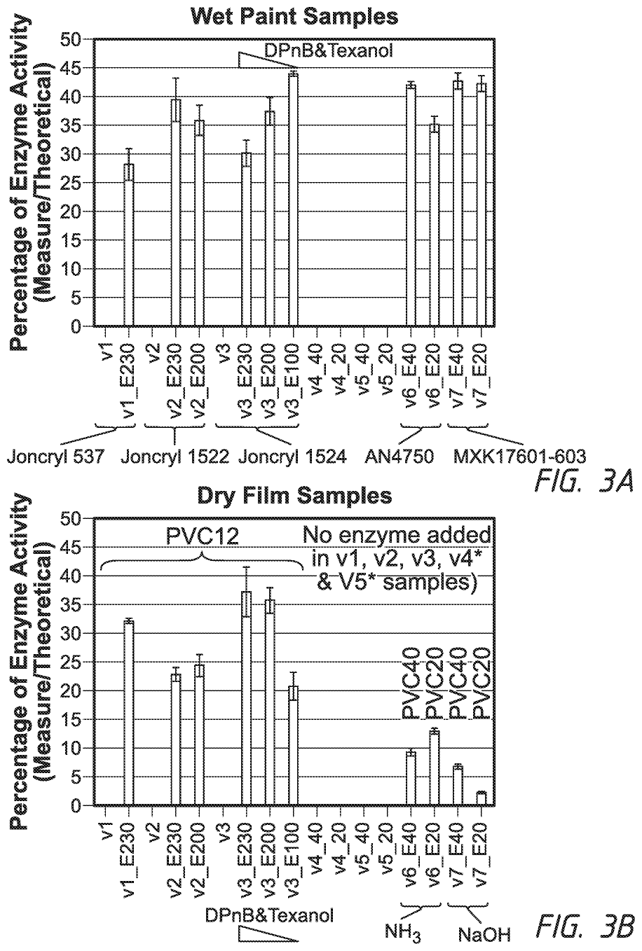

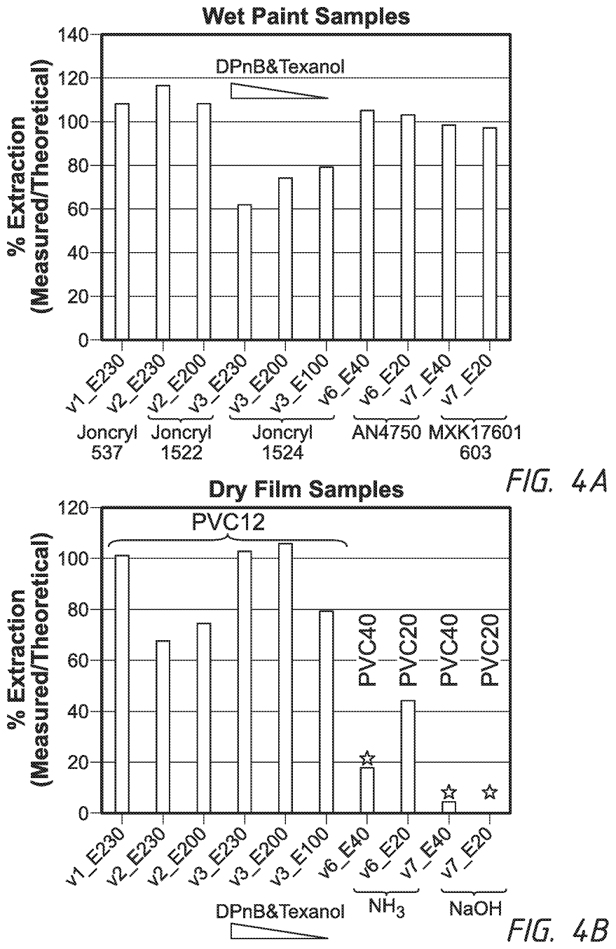

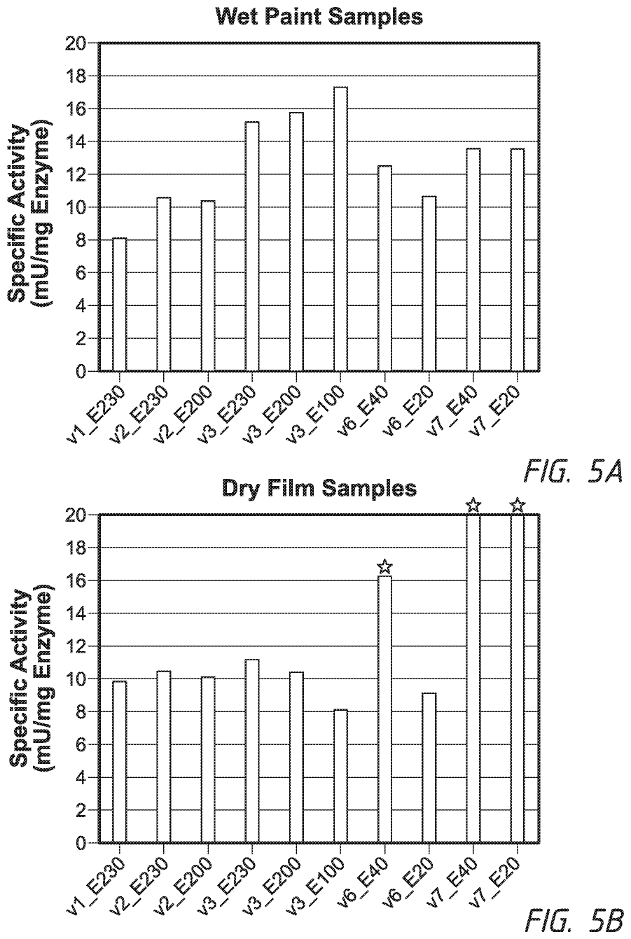

FIGS. 3A and 3B show recovered enzyme activity from “harsh” extraction of Group 2 wet paint samples and dry film samples, respectively. Approximately 30-45% of enzyme activity is recovered by “harsh extraction” for wet paint samples. Unexpectedly, coalescing agents DPnB and Texanol were found to affect activity extraction efficiency, but exhibited opposite trends in wet paint samples versus dry film samples. The v6 and v7 samples exhibited lower extracted activity as dry film compared to v1, v2 and v3 samples; and higher extractability was found from film samples comprising NH₃ than those with NaOH as the neutralizing agent. Enzyme quantification following “harsh” extraction of the wet paint samples and dry film samples is shown in FIGS. 4A and 4B, respectively. Extraction efficiency ranged from 60-100%, with wet paint showing more consistent extraction (100% extracted). Extractability was found to decrease with increasing levels of coalescing agents DPnB and Texanol. For the dry paint samples analyzed, lower amounts of the enzyme were extracted from the v6 and v7 samples. Additionally, higher extractability was observed from film samples comprising NH₃ than those with NaOH. FIGS. 5A and 5B depict data related to the specific activity of extracted enzyme (cellulase) from Group 2 wet paint samples and dry film samples, respectively. The specific activity of wet paint film samples ranged from 818 mU/mg. For dry film samples, similar specific activity values (8-11 mU/mg) are observed (except for very high values from v6 and v7 samples, possibly due to inaccurate protein quantification from the very low enzyme recovery samples shown in FIG. 4B). The reference specific activity of the cellulase tested is −18 mU/mg.

The studies above indicate that multiple formulations components affect enzyme extractability. Overall lower enzyme extraction and slightly lower specific activity of extracted enzyme was observed among the Group 2 samples as compared to Group 1 samples. Coalescing agents (DPnB and Texanol) were found to affect extraction efficiency, with opposite trends in wet paint samples versus dry film samples. Decreasing activity was observed with increasing coalescing agent content in wet paint, possibly due to mild enzyme inactivation by the organic solvent. The increasing activity with increasing coalescing agent content in dry paint is possibly due to better film formation (as DPnB and Texanol are evaporated after drying). The v6 and v7 samples tested have low extracted activity in dry film, which confirms the Group 1 finding of lower enzyme extraction from Duramite-containing film. Additionally, switching the neutralizing agent from NH₃ to NaOH was also found to decrease enzyme recovery. PVC level was not found to have any effect on enzyme extraction. These experiments also provide proof of concept that enzymes directly embedded in wet paint retain their activity following film formation.

### Example 3: Development of Assay Procedures to Analyze Enzyme Activity In-Film

In this example, assay protocols were developed to reliably and accurately determine enzyme activity directly in-film (rather than under a “harsh” extraction that favors maximal enzyme recovery). As used herein, in some embodiments, in-film activity refers to direct activity when placing a film under a “native” solution, “soft” extraction refers to enzyme that can be extracted in solution under a more native solution condition (as compared to the “harsh” optimal condition), and residual activity refers to activity left in-film after “soft” extraction. Agar plate assays for visualizing enzyme in-film activity were also developed and tested. A cellulase/mannanase was contained in the film samples.

### Development of an In-Film Total Assay, a Soft Extraction Assay, and an In-Film Residual Assay

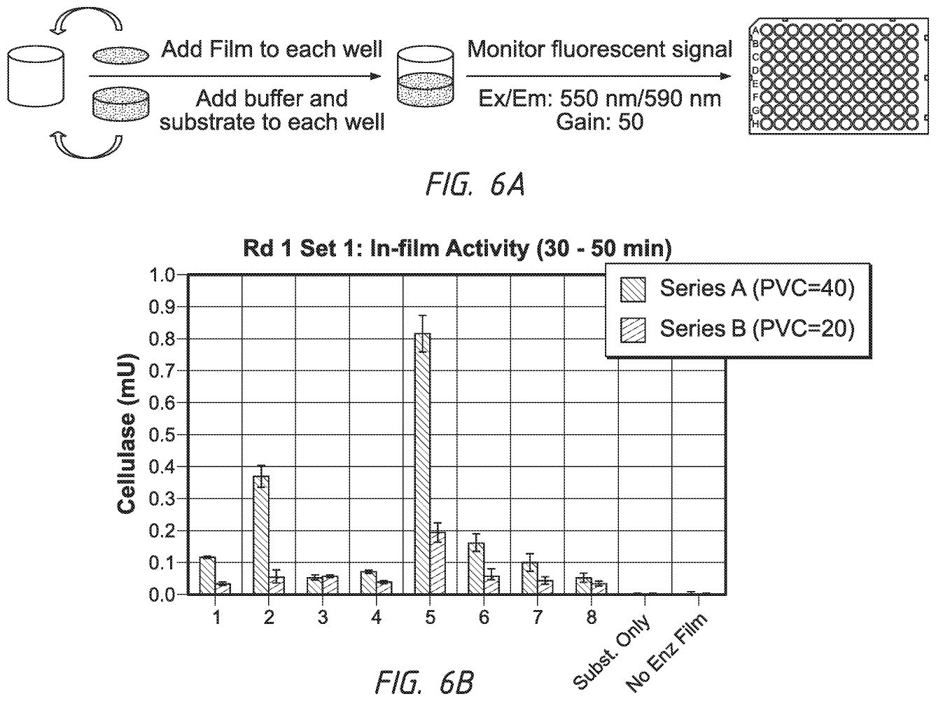

An assay for directly measuring in-film enzymatic activity without initial “harsh extraction” was developed (FIG. 6A). Approximately 5 mg (0.6 cm diameter) pieces of Group 1 Set 1 film samples (theoretically containing −8 mU of enzyme) were added to wells. Next, buffer (50 mM MES, pH 6, 0.25% Triton X 100) and enzyme substrate (0.1 mM Resorufin Cellobioside) were added to wells, and the fluorescent signal was monitored for 30 to 50 minutes (with an excitation 550 nm, an emission of 590 nm). Unexpectedly, it was discovered that in-film enzymatic activity can be directly measured without initial “harsh extraction.” (FIG. 6B). Further, it was observed that higher PVC levels consistently led to higher in-film enzymatic activity.

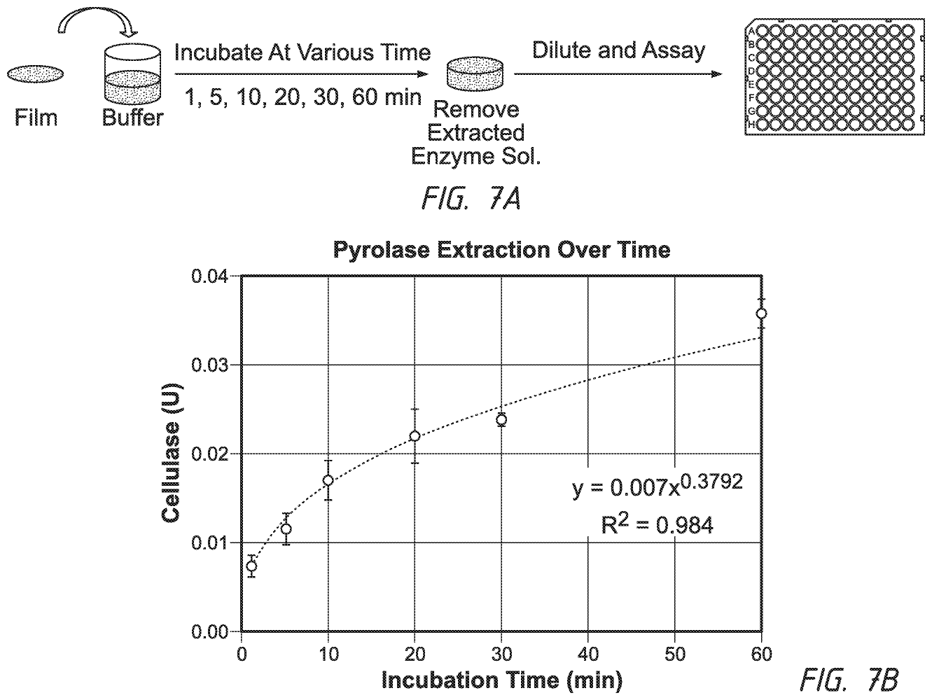

Next, a “soft” enzyme extraction from film sample using assay buffer under native conditions was developed. A 5.5 mg piece (0.6 cm diameter) of Group 1 Set 3 3B film sample (theoretically containing 47.8 U/g of enzyme) was used, and thus had a theoretical enzyme activity of 0.55 U per piece. As schematically depicted in FIG. 7A, the film was added to 200 μL of assay buffer (50 mM MES, pH 6, 0.25% Triton X 100) and incubated at room temperature for various times (1, 5, 10, 20, 30, and 60 minutes). The extracted enzyme solution was removed, diluted, and assayed according to the protocol described above. FIG. 7B shows the increase in cellulase extraction as the incubation time period increased.

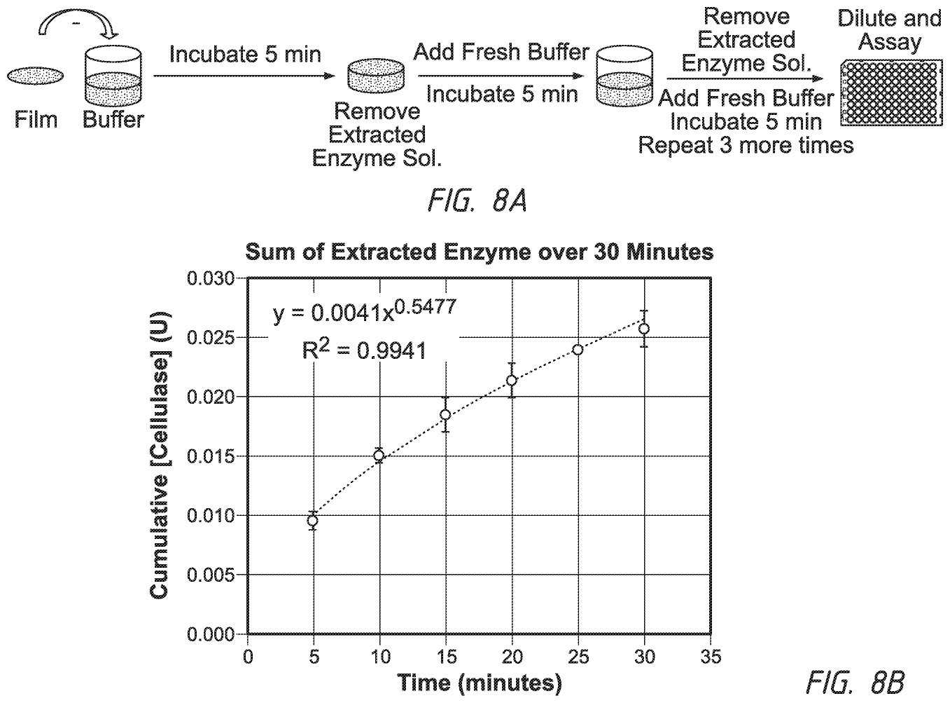

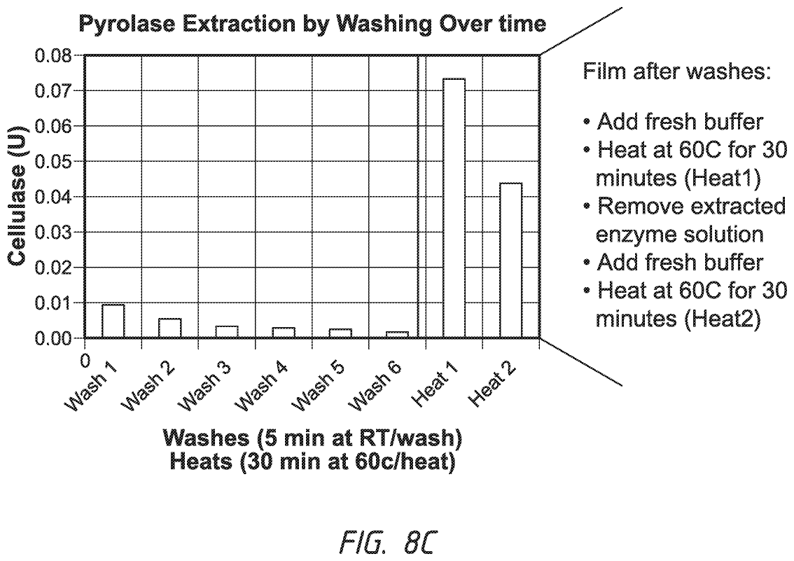

Studies were next conducted to determine the level of enzyme recovery from “soft” enzyme extraction as compared to “harsh” extraction. As schematically depicted in FIG. 8A, film was placed in the “soft” extraction buffer for five minutes at room temperature, the extracted enzyme solution was removed, fresh buffer was added, and this process was repeated several times. Extracted enzyme solutions were diluted and assayed as described above. FIG. 8B shows cumulative cellulase activity over 30 minutes with the six washes. Following six 5-minute washes at room temperature (Washes 1-6), fresh buffer was added to the film sample and incubated at 60° C. for 30 minutes (Heat 1). At the end of this incubation, the extracted enzyme solution was removed, fresh buffer was again added to the film sample, and a second incubation at 60° C. for 30 minutes was performed (Heat 2). Interestingly, it was found that there is low enzyme recovery from “soft” enzyme extraction as compared to “harsh” extraction (FIG. 8C).

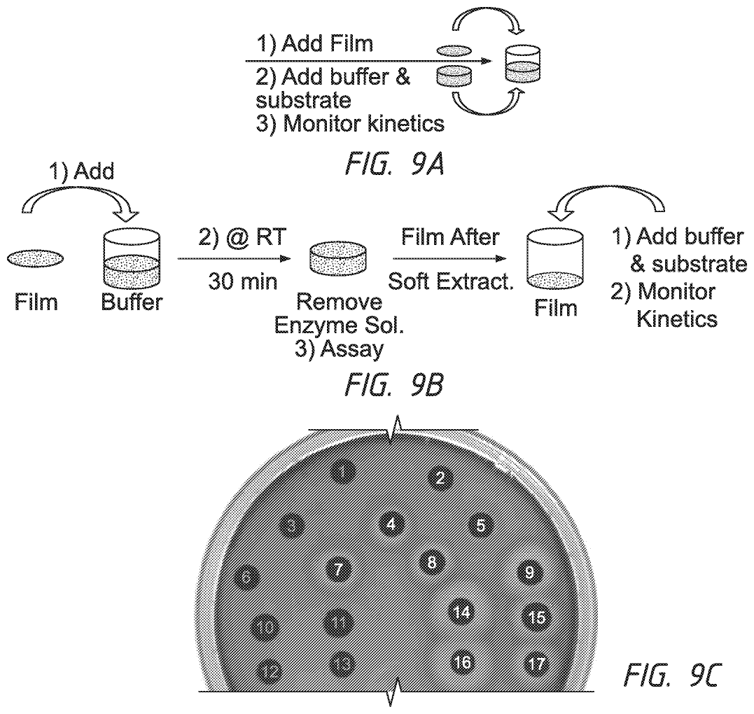

Based on the foregoing investigations, an in-film total assay, a soft extraction assay, and an in-film residual assay were developed for testing of the paint samples (schematically depicted in FIGS. 9A and 9B). The in-film total assay, soft extraction assay, and in-film residual assay each comprise a 30 minute incubation at room temperature in 50 mM MES Buffer with 0.25% Triton-X100, pH 6. However, the soft extraction assay includes assaying the enzyme activity of the extracted enzyme solution (comprising soluble protein), while the residual enzyme activity uses the film treated in the aforementioned “soft” extraction.

### Development of an Assay for Visualizing In-Film Enzyme Activity

The aforementioned assay methods comprise, in some embodiments, biochemical analysis of film samples by spectrophotometric methods. To enable visualization of in-film enzyme activity, an agar plate-based method was developed. An agar plate containing 5% agar media and 0.1% Azo-Barley Glucan (a native substrate for cellulase/mannanase) was prepared. Dry film samples were placed on the surface of agar, with the bottom film surface in contact with the agar. The agar media took a base color due to the presence of the substrate. As shown in FIG. 9C, incubation with film samples loaded with 0.1% cellulase (but not control films without enzyme) caused a clearing zone to appear in the agar around and underneath film samples; this effect is due to the long chain carbohydrate being cleaved by the enzyme. Unexpectedly, this assay was found to work when the paint film in a semi-dry state and/or when there is no soaking of the film in solution, which can advantageously mimic application conditions. The limited number of steps, the low cost, and the straightforward visual analysis of this assay provides many advantages and potential applications, such as, for example, use as a quick screening tool of the relative activity of enzymes in a plurality of dry paint samples. Collectively, these studies provide proof of principle that multiple classes of enzymes directly embedded in wet paint retain their activity, and further that they remain active following film formation.

### Example 4: In-Film Activity of Paint Samples with Different Formulations

In this example, the in-film enzyme activity assay methods developed in Example 3 were employed to examine enzyme activity in dry paint films under native conditions. The paint samples described above were assayed using the in-film total assays, soft extraction assays, and in-film residual assays of Example 3 to elucidate the impact of different paint formulation components (e.g., PVC levels, filler chemistries) on in-film enzyme activity.

### In-Film Activity Analysis of Group 2 Paint Samples

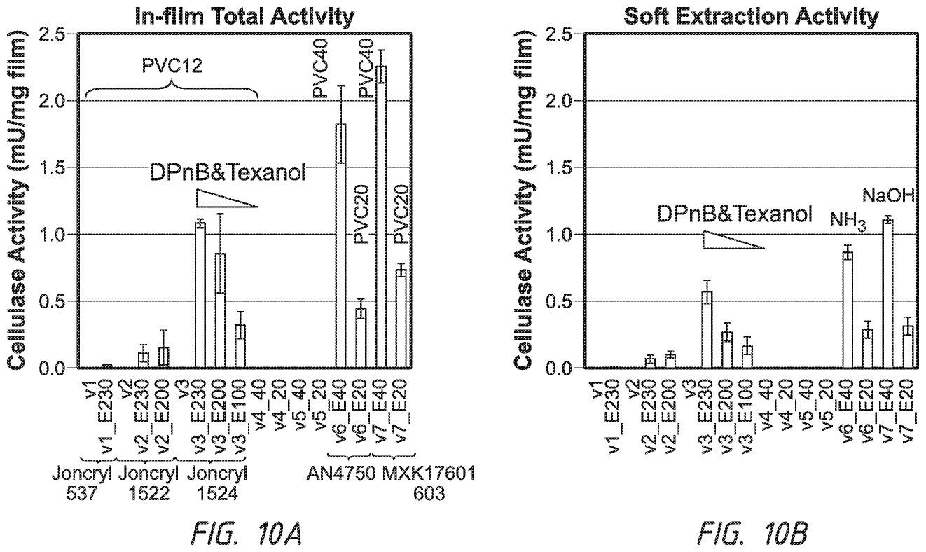

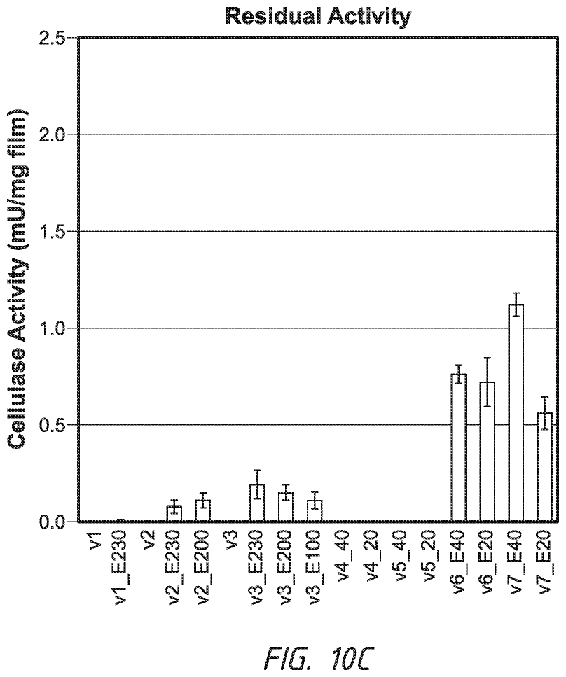

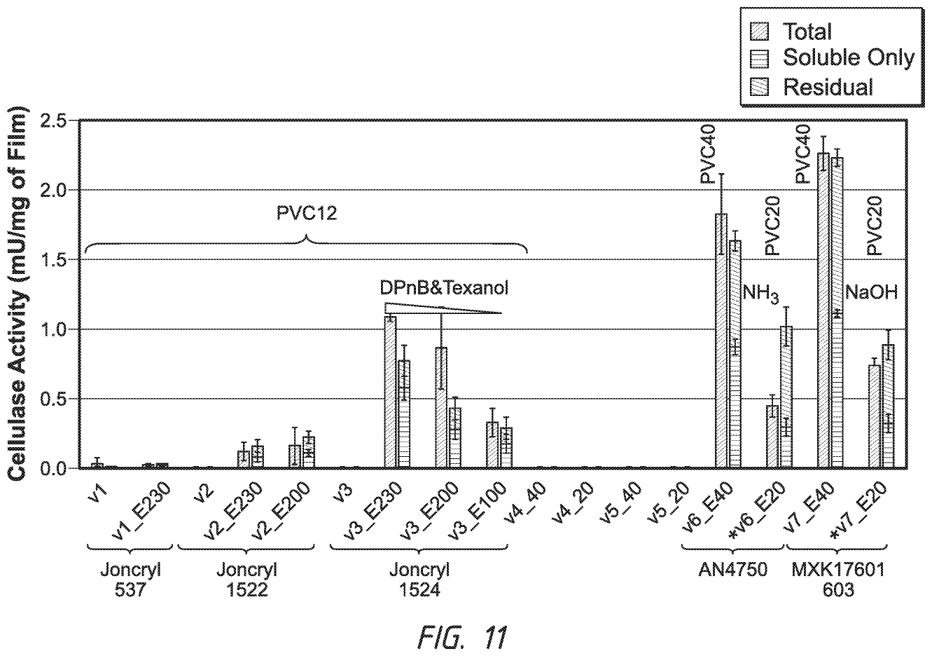

The in-film total activity, soft extraction activity, residual activity of cellulase detected in Group 2 dry film samples is shown in FIGS. 10A, 10B, and 100, respectively. Based on an assumption that 100% activity is 31.2 mU/mg, less than 10% of enzyme activity was detected by the in-film assay. Latex type was discovered to have an impact on in-film activity, with films comprising Acronal® 4750 and MXK17601-603 exhibiting superior cellulase activity. Additionally, in-film enzyme activity increased with increasing levels of coalescents (DPnB and Texanol). Unexpectedly, higher PVC levels were found to result in higher in-film enzyme activity.

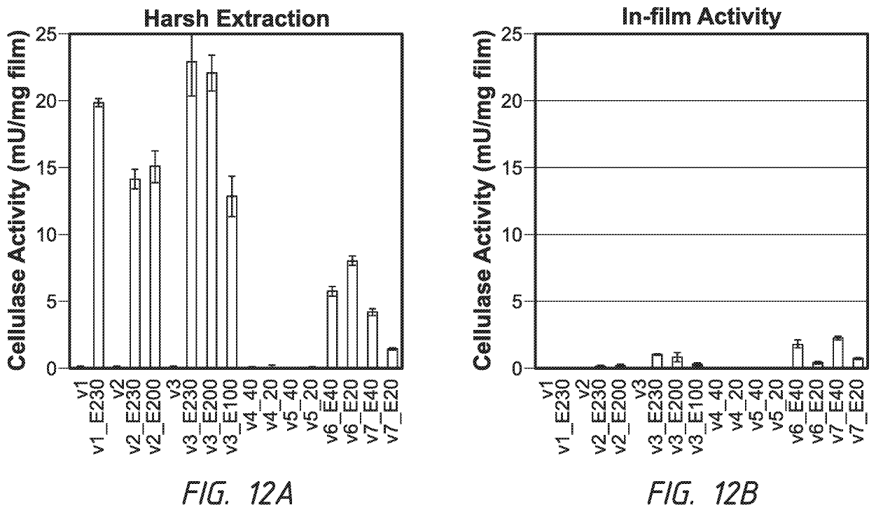

A set of experiments was performed to determine if the total in-film enzyme activity reflects the sum of soluble enzyme activity from “soft” extraction and residual enzyme activity in the film after soft extraction. As shown in FIG. 11, this hypothesis was confirmed. Interestingly, more than 50% of in-film activity was found to be derived from soluble enzyme (“soft” extraction). Next, studies were performed to elucidate the relationship between enzyme activity levels detected from in-film assays and enzyme activity levels detected from “harsh” extraction of dry film samples. As seen in FIG. 12, enzyme activity levels detected using in-film assays are only a small fraction of the enzyme activity detected following “harsh” extraction. Table 4 depicts percent in-film activity (Activity_{In_film}/Activity_{Ha}_{ₙ}ₕ Extraction) values calculated from the experiments depicted in FIG. 12, which is an activity comparison, not protein quantification. Interestingly, higher “harsh” extractability was not found to correlate with higher in-film activity. Our studies show that a number of paint formulation components, including DPnB levels, Texanol levels, PVC, neutralizer type, and latex type all contribute to enzyme extractability and in-film activity.

TABLE 4
PERCENT IN-FILM ACTIVITY

| | % In-film |
|---|---|
| Samples | Activity * |
| v1_E230 | 0.15 |
| v2_E230 | 0.84 |
| v2_E200 | 1.05 |
| v3_E230 | 4.75 |
| v3_E200 | 3.93 |
| v3_E100 | 2.56 |
| v6_E40 | 31.92 |
| v6_E20 | 5.61 |
| v7_E40 | 54.06 |
| v7_E20 | 51.31 |

* Activity comparison, not protein quantification

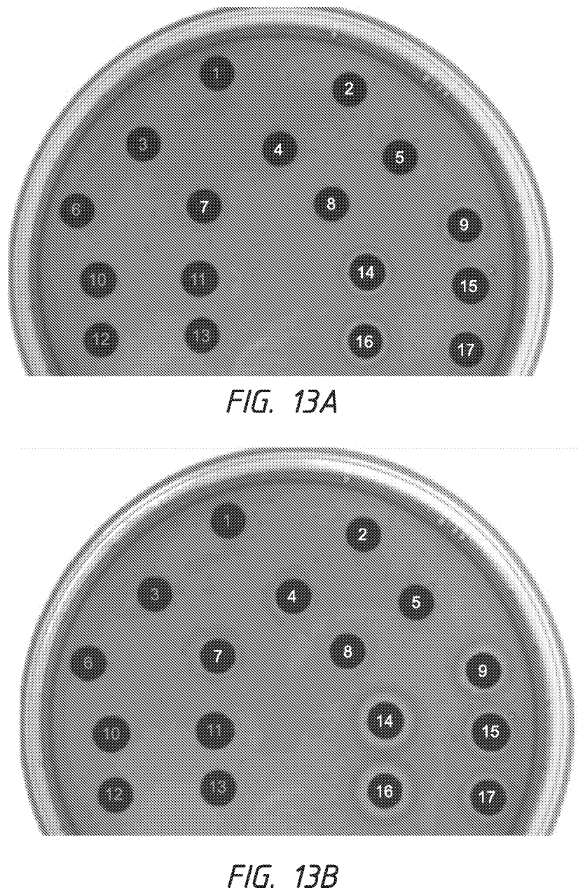

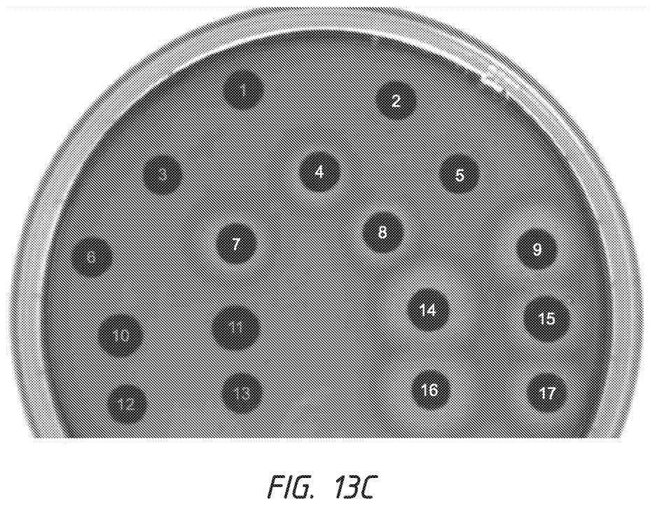

To confirm the results of the biochemical studies above, the in-film enzyme activity of Group 2 dry film samples was visualized using the agar plate method developed in Example 3. The paint formulations indicated in Table 1 were loaded with 0.1% cellulase (samples 2, 4, 5, 7, 8, 9, 14, 15, 16, 17); parallel film samples (1, 3, 6, 10, 11, 12, 13) not loaded with enzyme were used as controls. Plates incubated for 3, 7, and 22 at 37²C showed a progressive increase in zone of clearing around films containing enzymes (FIGS. 13A, 13B, and 13C, respectively). Importantly, these qualitative visual results are consistent with the in-film activity biochemical assay, including the discovery that increasing PVC levels increases in-film enzyme activity.

TABLE 5
PAINT FORMULATIONS ASSAYED USING THE AGAR PLATE METHOD

| Sample | 2 | 4 | 5 | 7 | 8 | 9 | Sample | 14 | 15 | 16 | 17 |
|---|---|---|---|---|---|---|---|---|---|---|---|
| Name | v1 | v2_E230 | v2_E200 | v3_E230 | v3_E200 | v3_E100 | Name | v6_E40 | v6_E20 | vl_E40 | V7_E20 |
| | J230 | | | | | | | | | | |
| Latex | Joncryl | Joncryl | Joncryl | Joncryl | Joncryl | Joncryl | Latex | AN4750 | AN4750 | MXK17601- | MXK17601- |
| | 537 | 1522 | 1522 | 1524 | 1524 | 1524 | | | | 603 | 603 |
| Neutralizer | | | | | | | Neutralizer | Ammonia | Ammonia | NaOH | NaOH |
| | | | | | | | Kronos | 100.0 | 48.8 | 100.0 | 48.8 |
| | | | | | | | 2310 | | | | |
| | | | | | | | Duramite | 100.0 | 48.8 | 100.0 | 48.8 |
| Dipropylene | 60 | 60 | 50 | 60 | 50 | 22 | | | | | |
| glycol n- | | | | | | | | | | | |
| butyl ether | | | | | | | | | | | |
| (DPnB) | | | | | | | | | | | |
| Texanol | 30 | 30 | 25 | 30 | 25 | 11 | | | | | |
| PVC | 12 | 12 | 12 | 12 | 12 | 12 | PVC | 40% | 20% | 40% | 20% |

### In-Film Activity Analysis of Group 1 Set 1 Paint Samples

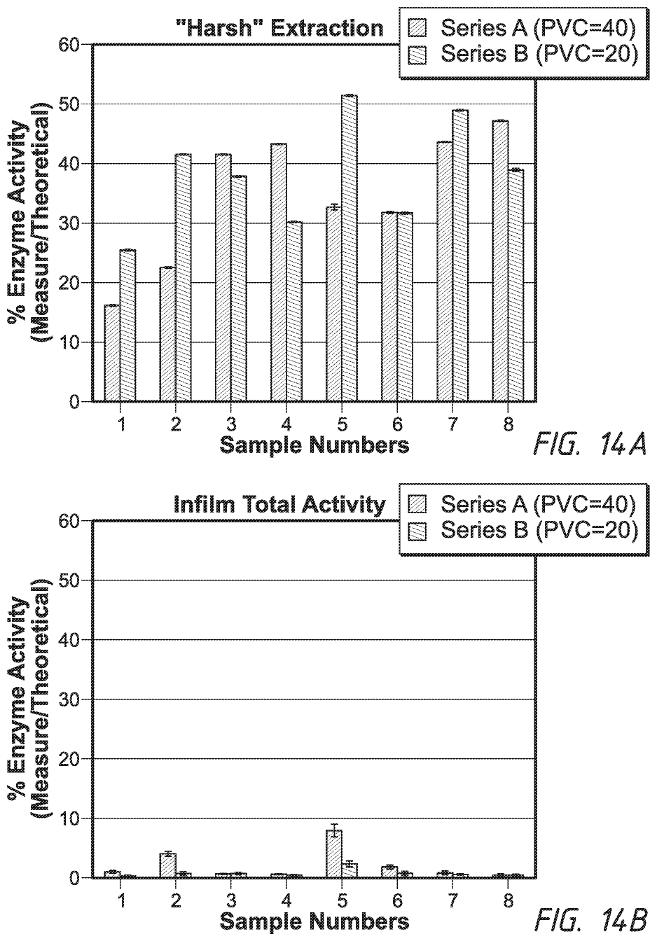

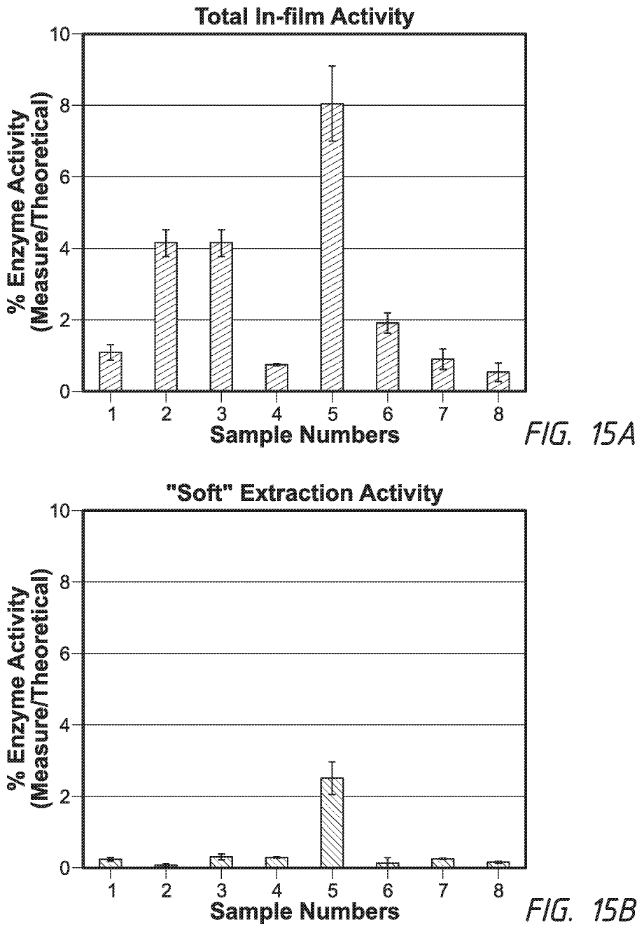

FIGS. 14A and 14B show enzyme activity detected by “harsh” extraction and total in-film activity assays of Group 1 Set 1 dry film samples, respectively. Consistent with the results of other experiments herein, higher in-film activity was detected from higher PVC samples; furthermore, consistent with the above results, this effect was not observed with “harsh” extraction. Less than 10% of enzyme activity was found to be detected by in-film assay. Sample 5 (comprising a SiO₂—Celatom filler) exhibited the highest in-film activity. These data provide further evidence that increasing PVC levels increases in-film enzyme activity. And consistent with results described above, higher “harsh” extractability does not correlate with higher in-film activity. Group 1 Set 1A dry film samples, which have a 40% PVC value, were further assayed by in-film total activity assays and “soft” extraction assays (FIG. 15). Roughly 25% of total in-film activity was found to be derived from soluble enzyme.

### In-Film Activity Analysis of Group 1 Set 3 Paint Samples

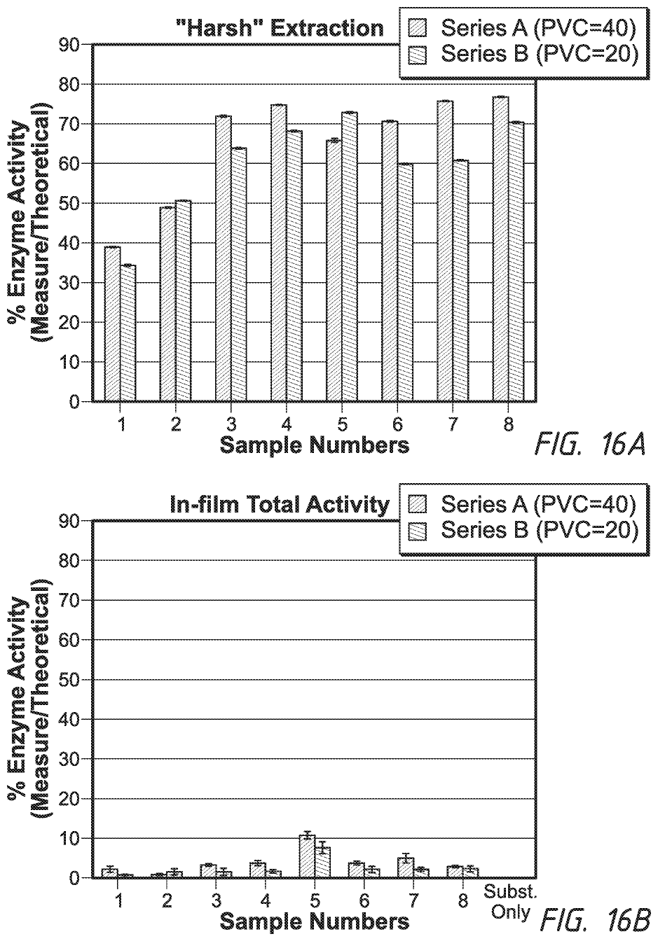

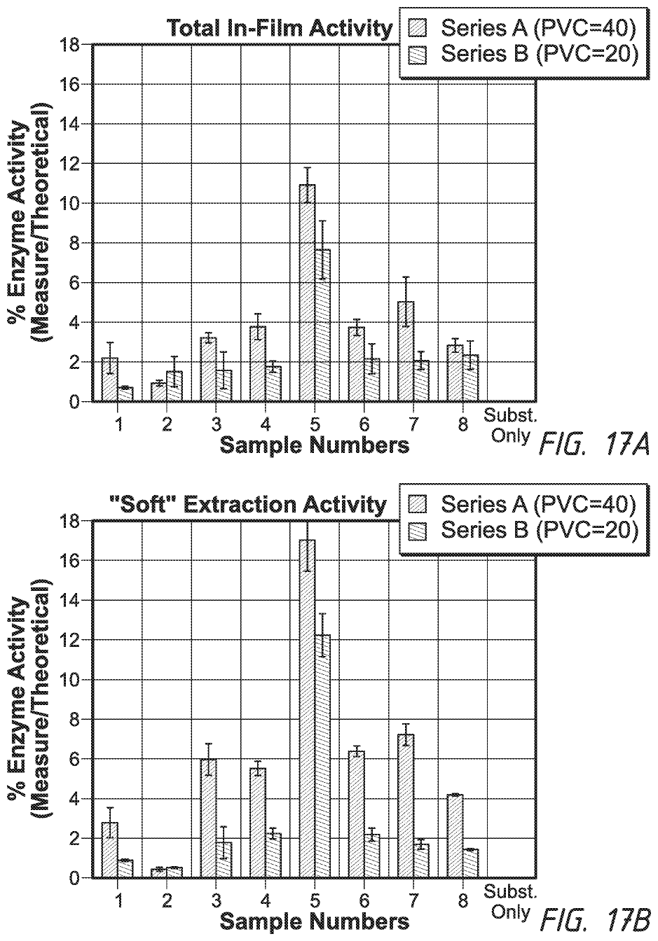

Group 1 Set 3 dry film samples were analyzed by “harsh” extraction and total in-film activity assays (FIGS. 16A and 16B, respectively). The Set 3 dry film samples comprise a higher loading of enzyme (−96 U/g) as compared to the Set 1 dry film samples assayed above (−1.8 U/g). Consistent with the results of other experiments herein, higher in-film activity was detected from higher PVC samples (and this effect was not observed with “harsh” extraction). Less than 12% of enzyme activity was found to be detected by in-film assay. Consistent with the results above, Sample 5 (comprising SiO₂-Celatom filler) exhibited the highest in-film activity. These data provide further evidence that increasing PVC levels increases in-film enzyme activity. And consistent with results described above, higher “harsh” extractability does not correlate with higher in-film activity. Group 1 Set 3 dry film samples were further analyzed by in-film total activity assays and “soft” extraction assays (FIG. 17). As seen with the Set 1 samples, the majority of the in-film activity comes from “soft” extraction.

The experiments described herein yielded a number of insights regarding the in-film enzyme activity by the assays developed as well as elucidate the influence of paint formulation components on in-film enzyme activity. In-film enzyme activity was found to be significantly lower than enzyme recovery from “harsh” extraction, and higher activity from “harsh” extraction does not correlate with higher in-from activity. The enzyme activity from in-film assay is significantly lower than that of “free” enzyme in solution at the theoretical inclusion level, with values of only about 10% or lower observed. The reason is unlikely due to irreversible enzyme inactivation in films, as shown by the results that the enzyme recovered from “harsh” extraction remain highly active. It is therefore reasonable to conclude that the enzyme remains active in films with reduced specific activity. This is possibly due to multiple factors that restrict enzyme catalytic conversion rate in-film, including diffusion of substrate and/or enzyme, substrate accessibility to enzyme, and enzyme conformation in film matrix. The mass balance of the total in-film activity was found to be roughly the sum of that of “free” enzyme that can be extracted by “soft” extraction and the residual activity remaining in the film. Finally, multiple formulation components were unexpectedly found to have a pronounced effect on in-film enzyme activity. Higher levels of coalescing agents were found to increase in-film activity. Paint formulations with higher PVC levels also demonstrated increased in-film activity. Additionally, latex type and filler type both impacted in-film activity, with formulations comprising SiO₂ (Celatom) exhibiting the highest activity. Importantly, these results were confirmed with the use of different types of assays as well as different types of paint formulations. Collectively, these studies provide further proof of principle that multiple classes of enzymes directly embedded in wet paint retain their activity, and further that they remain active following film formation.

### Example 5: Design of New In-Film Activity Assays for the Proof-of-Concept Analyses of Other Enzymes Classes

This example shows that other classes of enzymes directly embedded in wet paint retain their activity following film formation. Another aim of the present set of experiments was to develop biochemical assay and agar plate protocols that can reliably and accurately determine enzyme activity directly in-film for an expanded class of enzymes, including amylases, lipases, proteases, laccases, ureases. Agar plate screening is a rapid and efficient technique to visualize and screen enzyme activity. Finally, studies elucidating the impact of different paint formulation components (e.g., PVC levels, filler chemistries) on in-film enzyme activity for these enzyme classes were also undertaken.

### Agar Plate In-Film Activity Assays

Protocol

Agar plates prepared consisted of 2% Difco Agar Noble and an enzyme's substrate. The substrate was selected so that after the enzymatic conversion of the substrate to the product, a color change could be visually observed. The color change can come from the substrate or product itself, or from a contrasting agent co-imbedded in the agar with the substrate. To achieve homogeneity, a 2% Difco Agar Noble solution is boiled to a molten solution and cooled down on benchtop to −60° C. before addition of enzyme's substrates as follows:

Laccase substrate: 0.2 mM substrate (syringaldazine)

Lipase substrate: 1% Vegetable oil; 2% Nile Red

Amylase substrate: 0.7% red starch

Protease substrate: 0.5% Non-fat dried milk

The mixture was then poured to a media plate and cooled to room temperature to allow solidification.

Pieces of dry enzyme-containing paint films (e.g., a 0.6-cm in diameter circular piece cut by a hole puncher) was placed on top of the agar surface. The moisture from the agar partially wets the film, allowing the substrate to migrate to the paint film and allowing the enzyme from the film to migrate to the immediate adjacent area in the agar. Upon the conversion of the substrate to the product by the enzyme in the agar, a color change (increase in intensity, decrease in intensity, disappearance or appearance of color) can be visually observed and the image can be captured by an imager or camera.

Results

Amylases, lipases, proteases, and laccases were embedded in paint formulations equivalent to Group 1 Sample 7A/B (comprising Minex 4 filler [(NaK)Al2(AlSi3)O10(OH)21).

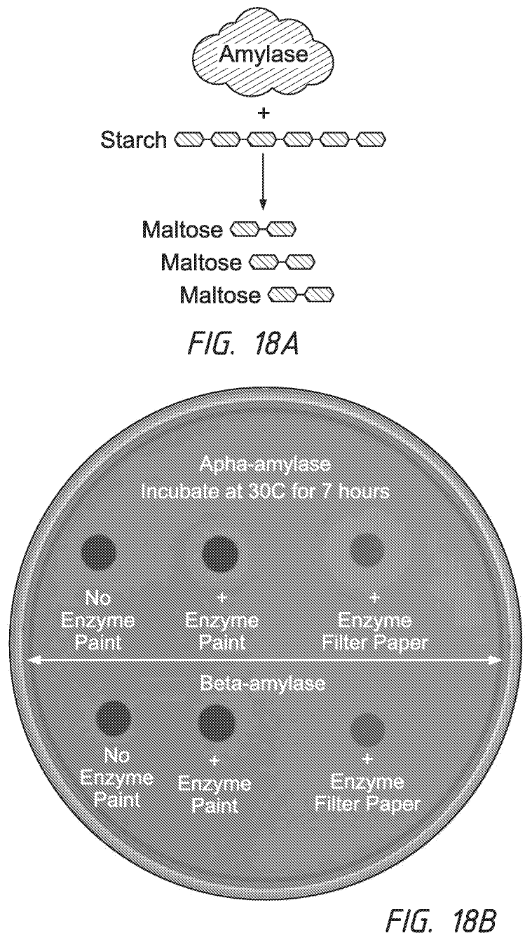

A red starch agar plate was prepared comprising 5% agar and 0.7% red starch. FIG. 18A shows a schematic representation of the enzyme-catalyzed reaction underlying the red starch agar plate assay according to several embodiments disclosed herein. Dry paint film samples comprising 0.1% alpha-amylase or 0.1% beta-amylase were incubated on the surface of the agar at 30° C. for 7 hours. Filter paper loaded with amylase and paint film not loaded with amylase serve as positive and negative controls, respectively. As shown in FIG. 18B, the dry film sample loaded with alpha amylase (endo and exo acting) showed good starch digestion (indicated by a zone of clearing) while beta amylase (exo acting only) showed poor starch digestion.

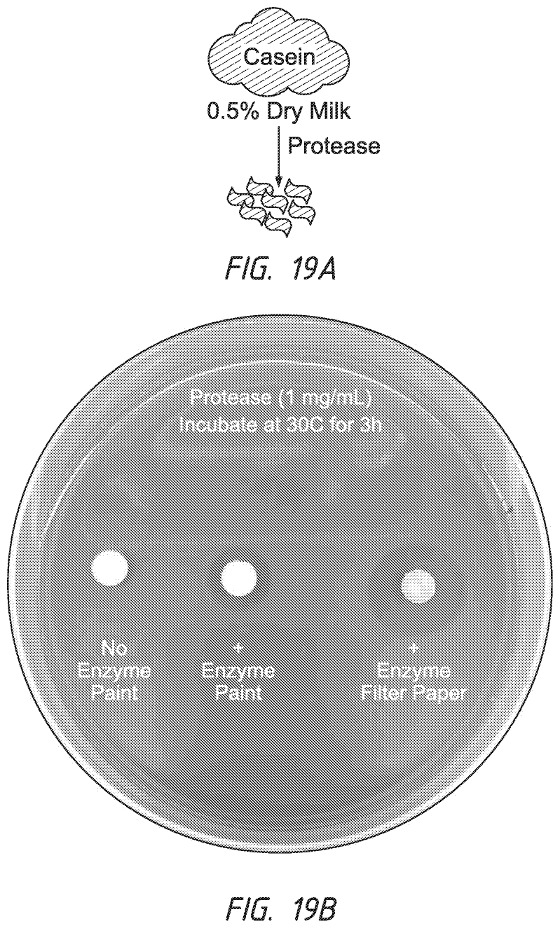

A milk agar plate was prepared comprising 2% agar and 0.5% non-fat dried milk (in some embodiments a blue dye was added for enhancing contrast). FIG. 19A shows a schematic representation of the enzyme-catalyzed reaction underlying the milk agar plate assay according to several embodiments disclosed herein. Dry paint film samples comprising 0.1% (1 mg/mL) protease were incubated on the surface of the agar at 30° C. for 3 hours. Filter paper loaded with protease and paint film not loaded with protease serve as positive and negative controls, respectively. As shown in FIG. 19B, the dry film sample loaded with acetyl lysine protease exhibited a zone of altered contrast surrounding the film.

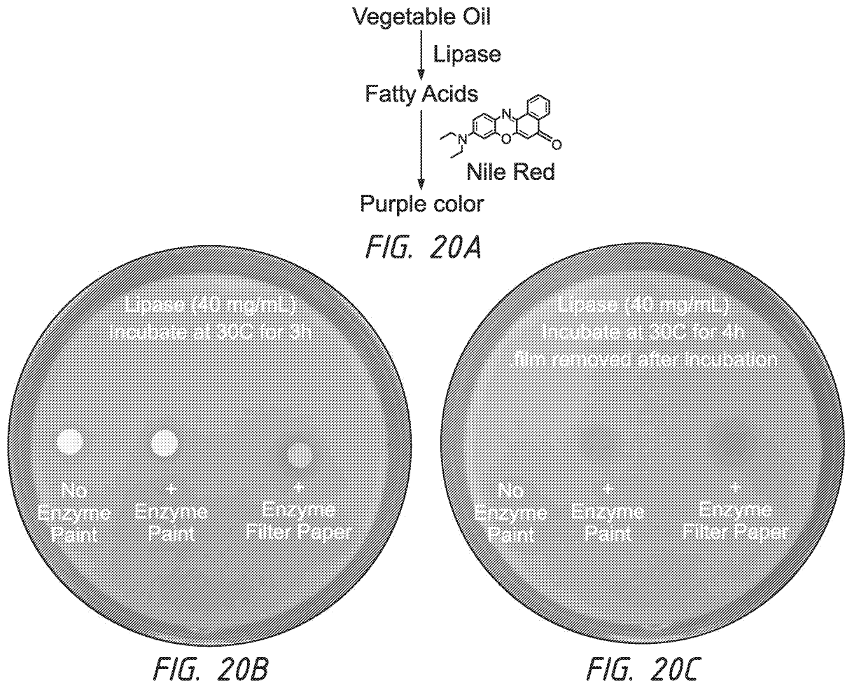

A vegetable oil agar plate was prepared comprising 2% agar, 1% vegetable oil, and 2% Nile Red. FIG. 20A shows a schematic representation of the enzyme-catalyzed reaction underlying the vegetable oil agar plate assay according to several embodiments disclosed herein. Dry paint film samples comprising 4% (40 mg/mL) lipase were incubated on the surface of the agar at 30° C. for 3 hours. Filter paper loaded with lipase and paint film not loaded with lipase serve as positive and negative controls, respectively. As shown in FIG. 20B, the dry film sample loaded with lipase exhibited a red zone surrounding the film. This plate was incubated for an additional hour and the film was removed, which revealed that the red shift in the color of the agar also occurred beneath the film (FIG. 20C).

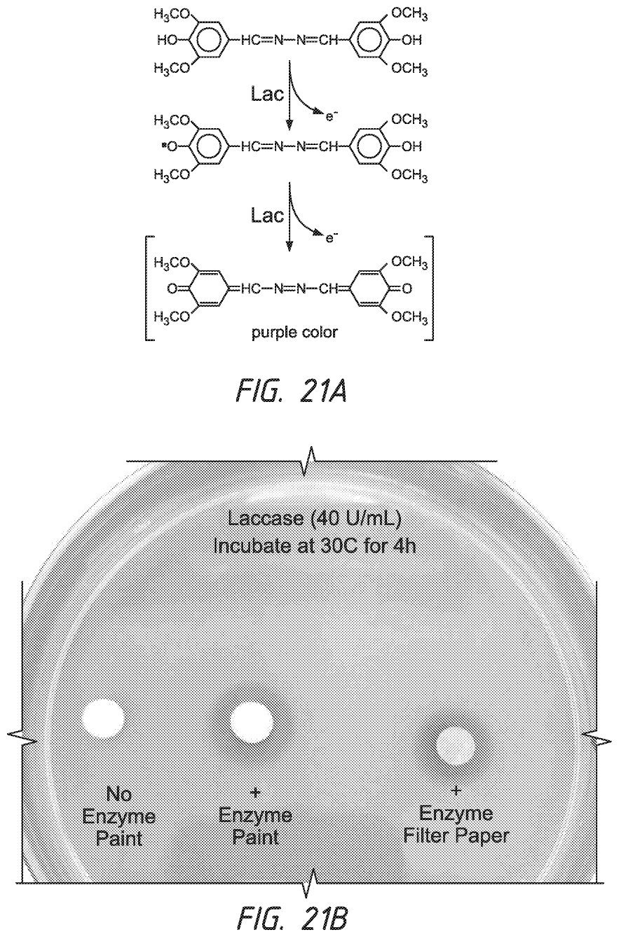

A syringaldazine (SGZ) agar plate was prepared comprising 2% agar and 0.2 mM SGZ. FIG. 21A shows a schematic representation of the enzyme-catalyzed reaction underlying the SGZ plate assay according to several embodiments disclosed herein. Dry paint film samples comprising 40 U/mL laccase were incubated on the surface of the agar at 30° C. for 4 hours. Filter paper loaded with laccase and paint film not loaded with laccase serve as positive and negative controls, respectively. As shown in FIG. 21B, the dry film sample loaded with laccase (a polyphenol oxidase) exhibited a purple zone surrounding the film owing to its ability to oxidize phenolic compounds.

These agar plate studies provide proof of concept that amylases, lipases, proteases, and laccases can directly embedded in wet paint and retain their activity in-film following film formation. Further, these experiments indicate that the agar plate assays that can reliably and accurately determine the activity of amylases, lipases, proteases, and laccases directly in-film. Given the significant impact of PVC levels on in-film cellulase activity of cellulase that we observed, agar plate assays investigating the impact of PVC levels and filler type on the in-film activity of amylases, lipases, proteases, and laccases were undertaken. Table 6 depicts the paint formulations for these classes of enzymes. The incorporations levels of amylase, protease, laccase, and lipase were 1%, 0.1%, 41.2 U/mL, and 0.1%, respectively. Dry film contains twice as much film due to solvent evaluation; thus, 0.01% in wet paint implies 0.02% in dry film.

TABLE 6
PAINT FORMULATIONS FOR TESTING MULTIPLE ENZYME CLASSES

| Raw Materials | Description | OA | OB | OC | OD |
|---|---|---|---|---|---|
| Filler Type | | Minex 4 | Minex 4 | Celatom | Celatom |
| Water | Solvent | 180.7 | 123 | 180.7 | 123 |
| Ammonia | Neutralizing amine | 0.7 | 0.7 | 0.7 | 0.7 |
| Dispex CX 4340 | Dispersing agent | 4 | 4.6 | 4 | 4.6 |
| Foamstar ST 2420 | Defoamer | 2 | 2.3 | 2 | 2.3 |
| Proxel DB 20 | Biocide | 3 | 3.5 | 3 | 3.5 |
| Kronos 2310 | TiO2 pigment | 200 | 97.7 | 200 | 97.7 |
| Filler | Filler | 200 | 97.7 | 200 | 97.7 |
| Attagel 50 | Thickener | 4 | 4.6 | 4 | 4.6 |
| Mix for 10-15 min, then add: | | | | | |
| Water | Solvent | 75 | 57.5 | 75 | 57.5 |
| Foamstar ST 2420 | Defoamer | 2 | 2.3 | 2 | 2.3 |
| Hydropalat WE 3320 | Wetting agent | 2 | 2.3 | 2 | 2.3 |
| Loxanol CA 5320 | Coalescing agent | 9 | 10.3 | 9 | 10.3 |
| Acronal 4750 | Binder | 425 | 564.9 | 425 | 564.9 |
| Rheovis PE 1331 | Rheology modifier | 12.5 | 14.4 | 12.5 | 14.4 |
| Rheovis PU 1191 | Rheology modifier | 1 | 1.2 | 1 | 1.2 |
| Total grams (equiv. to lbs/100 gal) | | 1120.9 | 986.8 | 1120.9 | 986.8 |

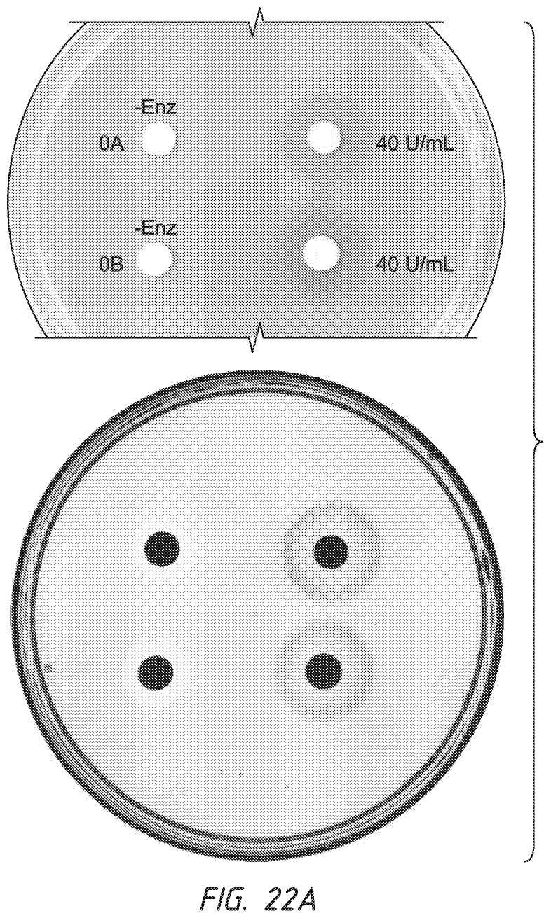

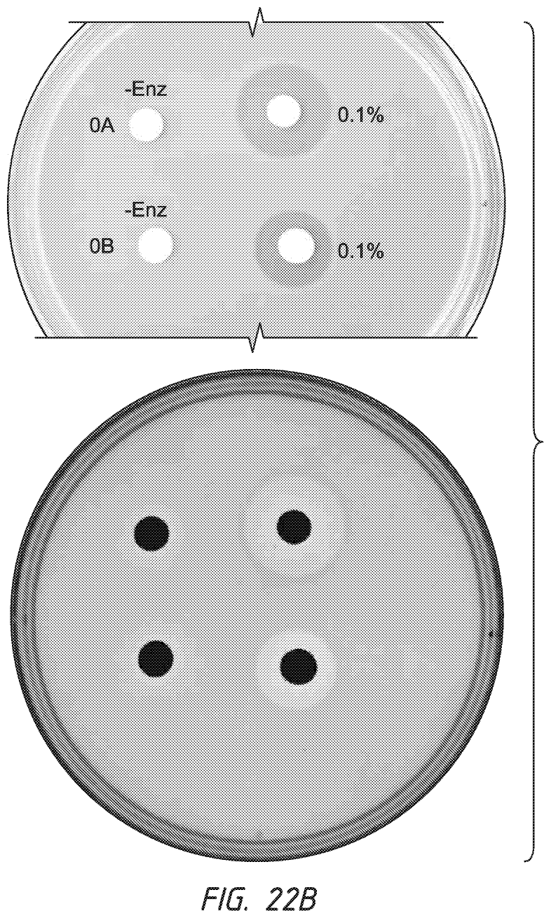

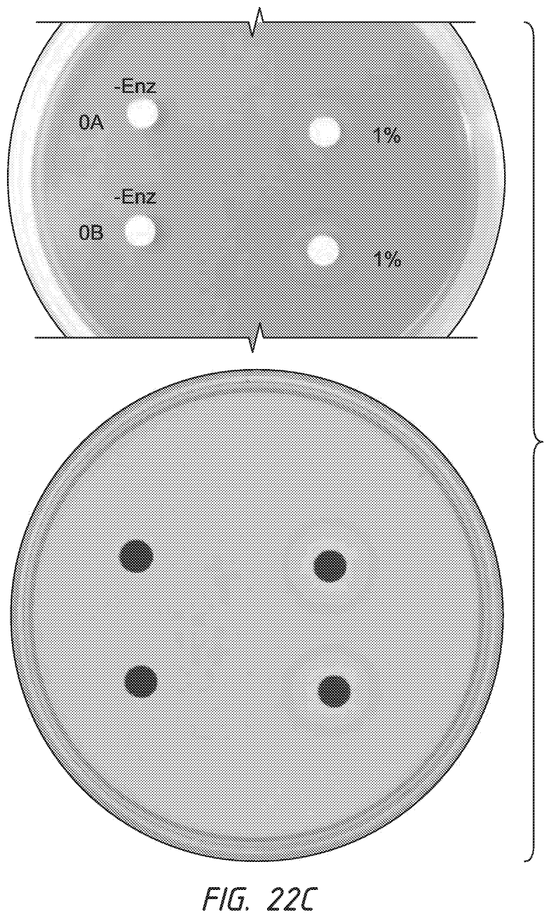

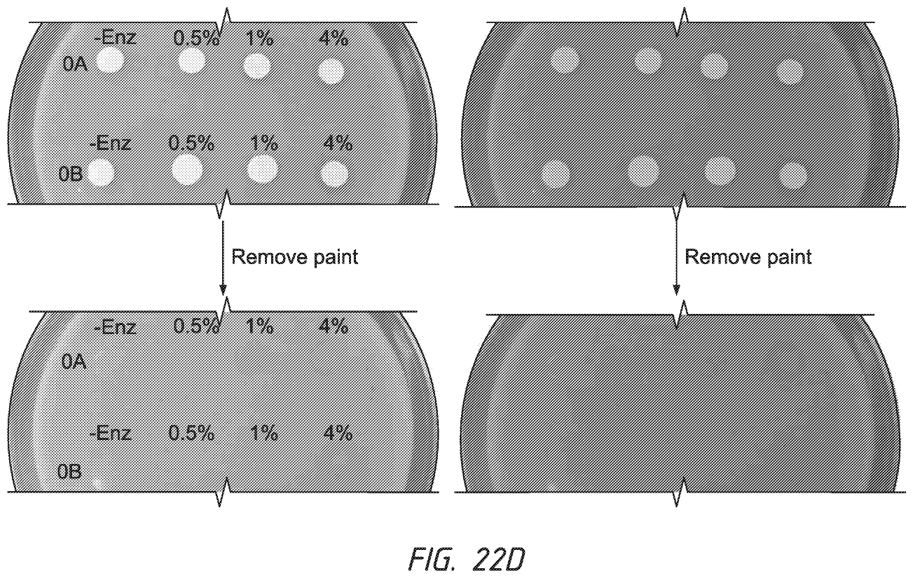

Laccase, protease, alpha-amylase, and lipase were added to paint formulations comprising a Minex 4 filler and a PVC of either 40% (OA samples) or 20% (OB samples). FIG. 22 shows that the positive impact of PVC levels on in-film enzyme activity is also readily apparent with films comprising lipases and proteases.

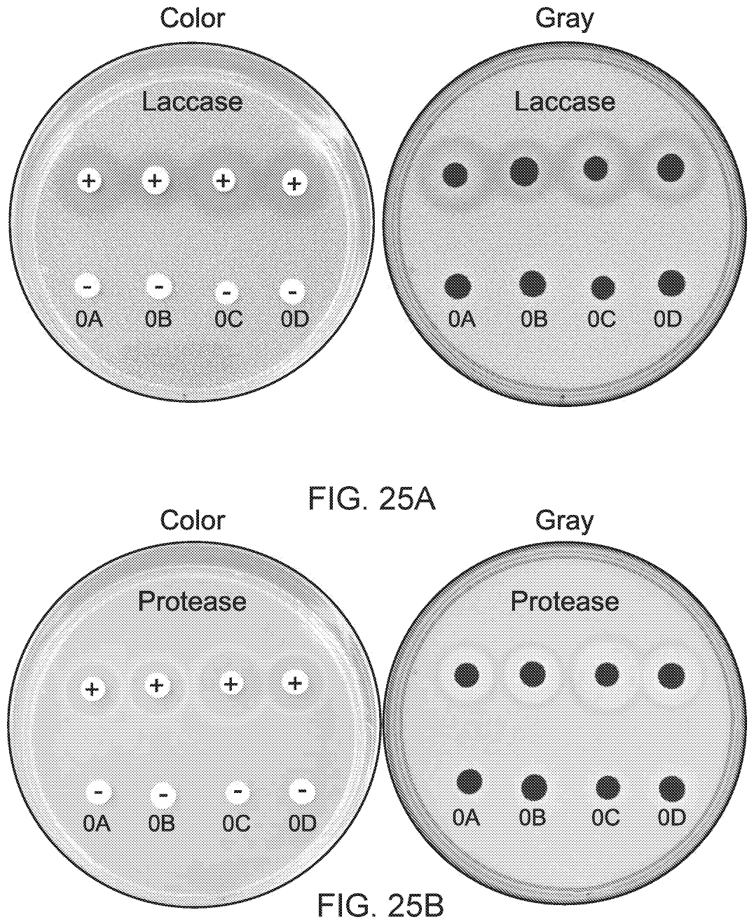

Additionally, paint formulations comprising either Minex 4 filler (OA and OB samples in Table 6) or Celatom filler (OC and OD samples) and a PVC of either 40% (OA and OC samples) or 20% (OB and OD samples) were embedded with laccase and protease, and the films were assayed via agar plate. Both enzyme classes exhibited higher in-film activity in paints formulated with Celatom as the filler than Minex 4 (FIG. 25). In-film activity was found to increase with higher PVC level for all laccase samples tested as well as for proteases embedded in Celatom-containing paint; however, this trend was not observed with protease embedded in Minex-containing paint.

### Biochemical In-Film Activity Assays

Problem & Solution for Biochemical In-Film Activity Assay

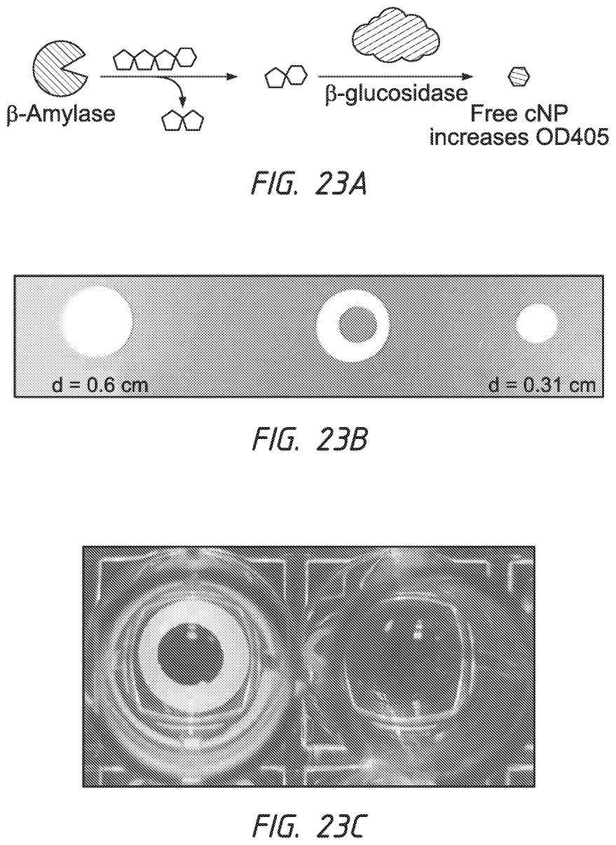

Colorimetric assays are convenient and fast in-vitro assays that evaluate enzyme activity based on the change in absorbance at a specific wavelength of a substrate upon interacting with an enzyme. This assay requires an incident light path to pass through a testing solution and records the absorbance of that light. In the case analyzing enzyme activity in dry paint films, measurement of absorbance is not feasible as the dry paint film blocks the light path. This light blockage can cause a number of issues depending on the enzyme, paint, and substrate being tested, including: 1) an inaccurate readout of enzyme activity; 2) an extended assay period required; 3) higher levels of substrate and/or enzyme required; and/or 4) incompatibility of particular paint formulations with the assay. This challenge is particular problematic as significant screening can be required to elucidate the optimal paint formulation for a given enzyme and/or contemplated paint application. Provided herein is a solution to this problem: configuring the film to allow the incident light path to pass through, such as, for example, by removing an interior portion of the film before it is placed in the sample well. In some embodiments, this method comprises cutting out the middle part of the film to allow light to pass through as shown in FIG. 23B). Importantly, as shown in FIG. 23C, this solution is compatible with the assay of films in a 96-well plate. In some embodiments, dry paint films containing enzymes are cut into an “O-ring shape” pieces using two different sizes of hole punchers. First, a bigger hole puncher with a 0.6 cm diameter cuts the dry paint film into a circular piece that fits perfectly into a well of a 96-well plate. This circular piece of dry paint film is further cut with a smaller hole puncher (diameter=0.31 cm) at the center. This creates a 0.6 cm disk with a 0.31 cm hollow center (or “O-ring shape”). As a result, the hollow center allows the incident light to pass through the center of each well and enable recording of the absorbance of that light, while enzymes in “O-ring” portion of the paint film can interact with the substrate solution added to the well. Importantly, this method allows detection of enzyme activity from enzyme that was released into the solution from the paint film as well as immobilized enzyme in the dry paint film. In addition, it facilitates the evaluation of enzyme in different dry paint film using a microtiter plates in a high throughput manner. The dimensions described here are fitted for 96-well microtiter plate format; the sizes can be adjusted for other plate or non-plate formats for absorbance measurement.

Colorimetric Assays Procedures

5 mg of O-ring shape dry paint film containing an enzyme (laccase, lipase, protease, or amylase) was prepared using 2 different sizes of hole punchers (out diameter=0.6 cm, inner diameter=0.31 cm) and placed in a well of a 96 well plate. The activity assay conditions were as follows:

Laccase: 200 μL of 100 mM potassium phosphate buffer (pH 6.5) that contains 0.02 mM substrate (syringaldazine) was added to the well. Change in absorbance at 530 nm over time was recorded to determine the activity of laccase.

Lipase: 200 μL of 50 mM HEPES buffer (pH 7.5) that contains 100 mM NaCl, 20 mM CaCl₂), 0.01% Triton-X100 and 1 mM substrate (4-nitrophenyl octanoate) was added to the well. Change in absorbance at 405 nm over time was recorded to determine the activity of lipase.

Amylase: 200 μL of 50 mM HEPES buffer (pH 7.5) that contains 0.1 mg/mL BSA, 1 U/mL of p-glucosidase, and 4 mM substrate (2-chloro-4-nitrophenyl-p-D-maltotrioside) was added to the well. Change in absorbance at 405 nm over time was recorded to determine the activity of amylase. FIG. 23A shows the schematic representation of the colorimetric in-film amylase activity assay.

Protease: 200 μL of 50 mM HEPES buffer (pH 7.5) that contains 1 mM substrate (Succinyl-Ala-Ala-Pro-Phe-p-nitroanilide) was added to the well. Change in absorbance at 405 nm over time was recorded to determine the activity of protease.

Urease: 100 μL of 10 mM Phosphate buffer (pH 7.0) that contains 10 of substrate (urea solution provided with Urease Assay Kit from Sigma Aldrich) was added to dry paint film in a 96-well plate and incubated for 10 minutes. During this time, urease from paint converts urea into ammonia and carbon dioxide. 150 μL of detecting agents (Reagent A and Regent B provided with Urease Assay Kit from Sigma Aldrich) were then added to the solution. These reagents inhibit urease activity and allow ammonia to react with detecting agents to generate a blue color (wavelength is between 600-700 nm). Absorbance at 600-700 nm was recorded and compared to a urease standard curve to determine the activity of urease.

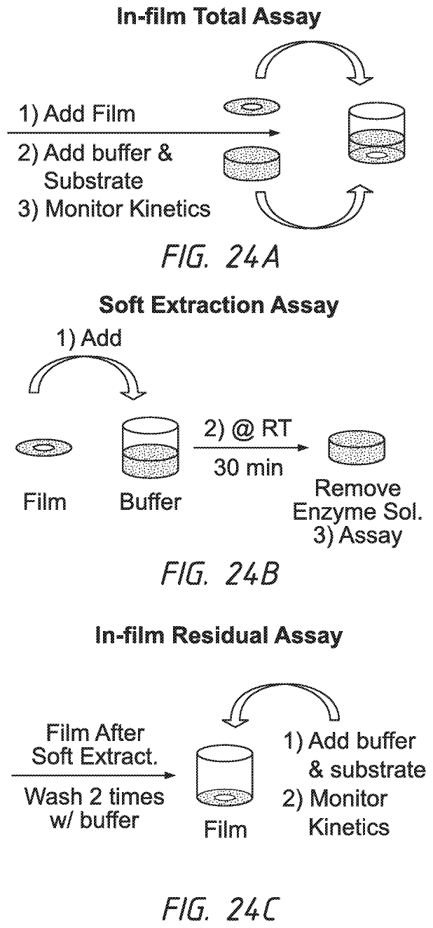

The total in-film activity assay comprises incubating the film with the assay buffer at room temperature for 30 minutes and measuring activity. The “soft” extraction activity assay comprises incubating the film in assay buffer for 30 minutes, removing the film, and measuring the activity of the soluble protein. The in-film residual assay comprises washing the film from the “soft” extraction assay in buffer and measuring the residual enzyme activity in the film. FIG. 24 shows schematic representations of an in-film total assay, a soft extraction assay and an in-film residual assay (FIGS. 24A, 24B, and 24C, respectively) according to several embodiments disclosed herein.

Results

Amylase (20 mg/g), lipase (2 mg/g), protease (0.2 mg/g), and laccase (82 U/g) were embedded in paint formulations in Table 6, comprising either Minex 4 filler (OA and OB samples) or Celatom filler (OC and OD samples) and a PVC of either 40% (OA and OC samples) or 20% (OB and OD samples). The film samples were assayed for total in-film, “soft” extraction and in-film residual activities.

Urease (4 U/g) was embedded in paint formulations equivalent to Group 2 Sample v7_E40/E20 (depicted in Table 7) which comprises the filler Duramite (CaCO₃) and comprises NaOH as the neutralizing agent.

TABLE 7
PAINT FORMULATIONS EMBEDDED WITH UREASE

| Formulation Name | | v5_40 | v5_20 |
|---|---|---|---|
| Latex | | MXK17601-603 | MXK17601-603 |
| Neutralizer | | NaOH (29%) | NaOH (29%) |
| Water | Solvent | 90.4 | 61.5 |
| Neutalizer | Neutralizing amine | 0.75 | 0.86 |
| Dispex CX 4340 | Dispersing agent | 2 | 2.3 |
| Foamstar ST 2420 | Defoamer | 1 | 1.15 |
| Proxel DB 20 | Biocide | 1.5 | 1.73 |
| Kronos 2310 | TiO2 pigment | 100 | 48.8 |
| Duramite | Filler | 100 | 48.8 |
| Attagel 50 | Thickener | 2 | 2.3 |
| Total | | 297.6 | 167.5 |
| Mix for 10-15 min, then add: | | | |
| Water | Solvent | 37.5 | 28.7 |
| Foamstar ST 2420 | Defoamer | 1 | 1.15 |
| Hydropalat WE 3320 | Wetting agent | 1 | 1.15 |
| Loxanol CA 5320 | Coalescing agent | 4.5 | 5.17 |
| Binder | Binder | 212.5 | 282.5 |
| Rheovis PE 1331 | Rheology modifier | 6.25 | 7.18 |
| Rheovis PU 1191 | Rheology modifier | 0.5 | 0.58 |
| Total grams (equiv. to lbs/100 gal) | | 560.9 | 493.9 |
| Viscosity target | KU | 95-100 | 95-100 |
| Viscosity target | ICI | 1.0-1.5 | 1.0-1.5 |
| Volume Solids | | ₃₉% | ₃₉% |
| PVC | | 40% | 20% |

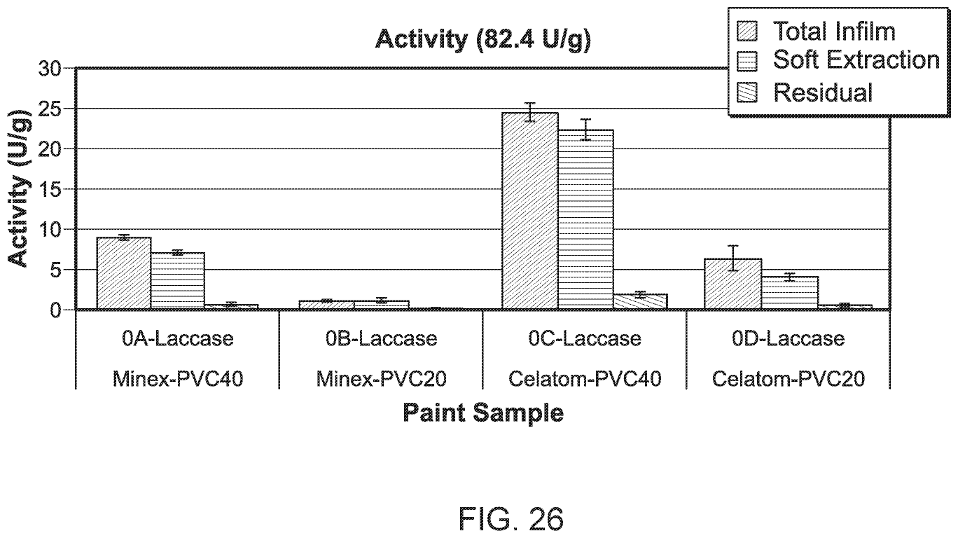

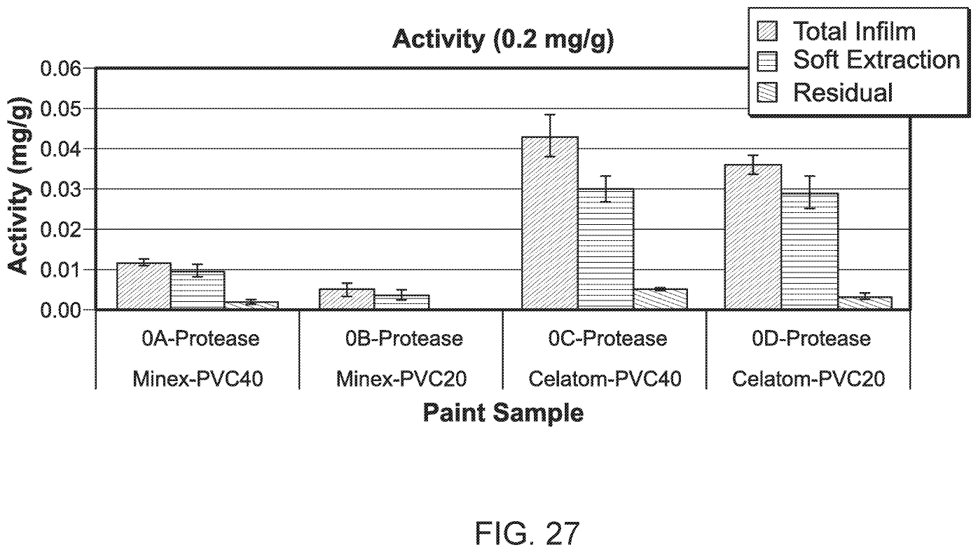

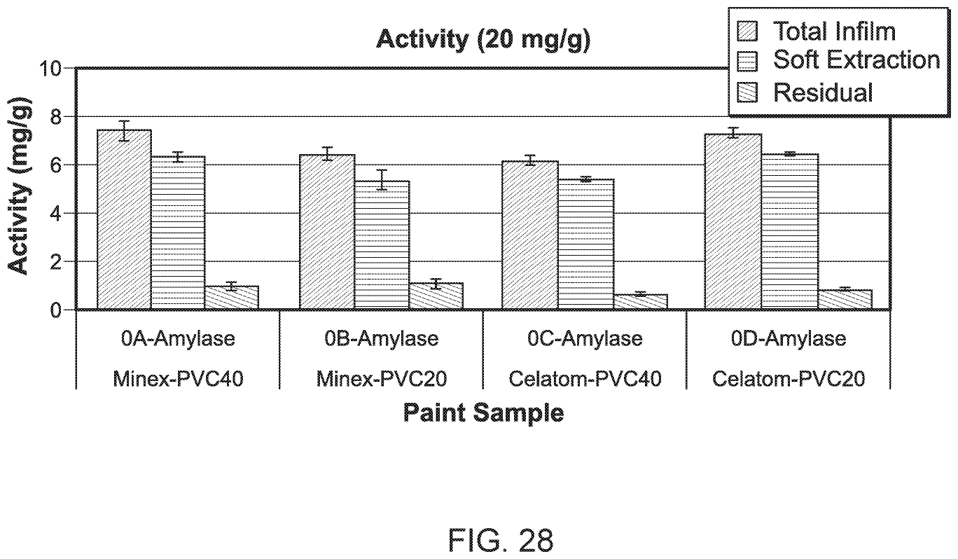

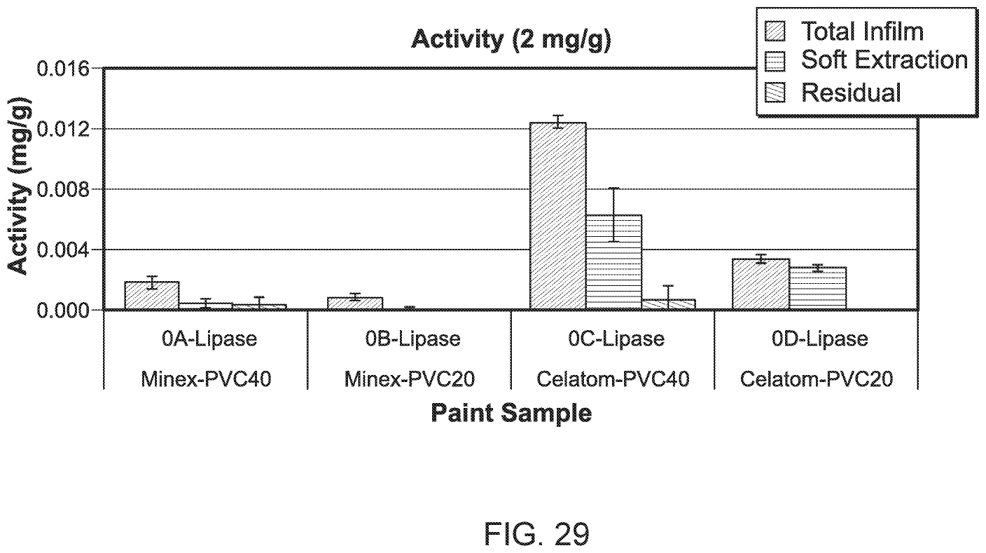

For paints embedded with laccase, protease, or lipase, substantially higher in-film enzyme activity was observed in Celatom-containing paints than that of Minex 4, and higher PVC levels resulted in higher in-film activity (FIGS. 26, 27 and 29). This is consistent with the in-film activity assays of Group 1 and Group 2 paint samples embedded with cellulase. The highest in-film activity (in Celatom-containing paint with PVC of 40%) measured at −30% for laccase, −20% for protease, and −6% for lipase, respectively, of added enzyme activity level. However, paints embedded with amylase exhibited similarly high in-film activity (−j 30% of added enzyme activity level) across all paint formulations (FIG. 28).

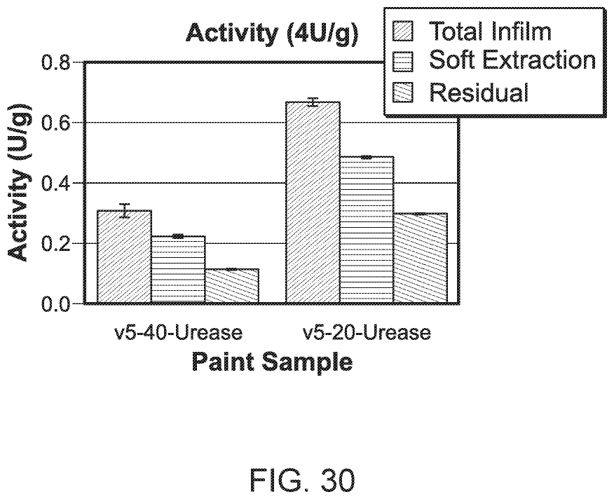

Unexpectedly, PVC levels had the opposite effect on urease in-film activity, with lower PVC levels resulting in higher in-film urease activity (FIG. 30). The highest in-film activity (in paint with PVC of 20%) measured at −20% of added urease activity level. For films embedded with laccase, protease, amylase, urease, or lipase, the majority of the in-film activity can be attributed to “soft” extracted enzyme, with very low residual activity detected.

### Conclusions

Both the agar plate assays and the in-film biochemical activity assays work unexpectedly well across a variety of enzymes classes and paint samples. Further, as validation of these methods, similar results were obtained by the other methods described herein across different paint formulations and enzyme classes. Configuring the film to allow light to pass through by, for example, removing an interior region, worked unexpectedly well and across a range of enzyme classes and paint formulations. These experiments provide proof-of-concept for the use of the agar assays and biochemical assays developed herein as screening tools. In-film enzyme activity, measured as % of added enzyme activity level, varied significantly among different enzyme classes. The majority of this in-film activity can be attributed to “soft” extracted enzyme, as residual film activity is very low. Finally higher PVC levels consistently result in higher in-film activity for most enzyme classes; however, urease showed an opposite trend; and paint with Celatom filler has higher in-film enzyme activity than paint with Minex 4 filler for most enzyme classes. Collectively, these studies provide further proof of principle that multiple classes of enzymes directly embedded in wet paint retain their activity, and further that they remain active following film formation.

### Example 6: In Situ Localization and Activity of Enzyme in Film

This example shows microscopic methods for the visualization of the in situ localization of enzyme in dry paint film and in wet paint, and the in situ activity of enzyme dry paint film. Another aim of these investigations was to discover the impact of paint formulation ingredients on the distribution of enzyme in the film and activity within film. Finally, these studies were conducted to provide further confirmation of the in-film activity of enzymes that was detected and measured by other assay methods.

### Visualization of In Situ Enzyme Activity in Film

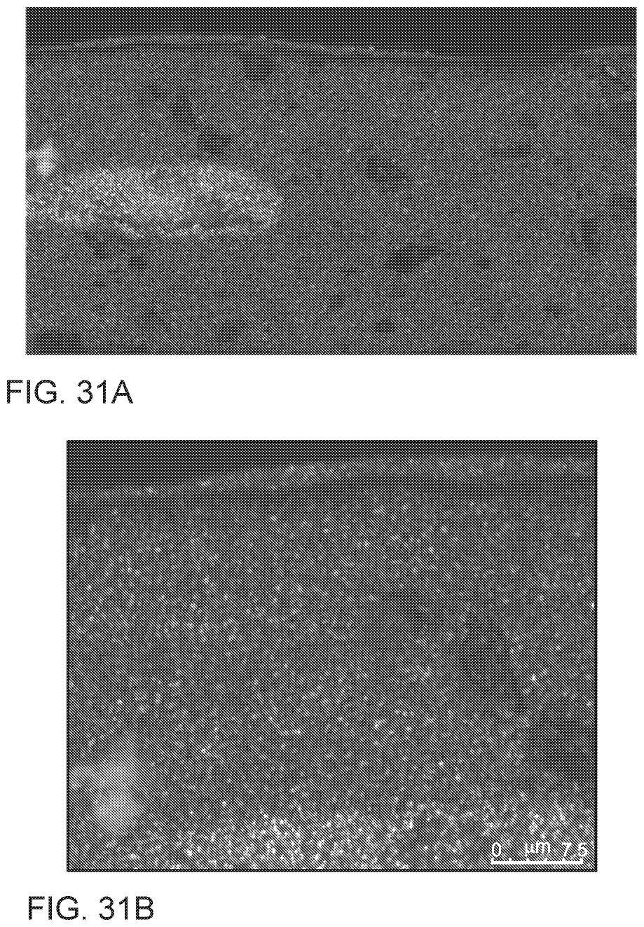

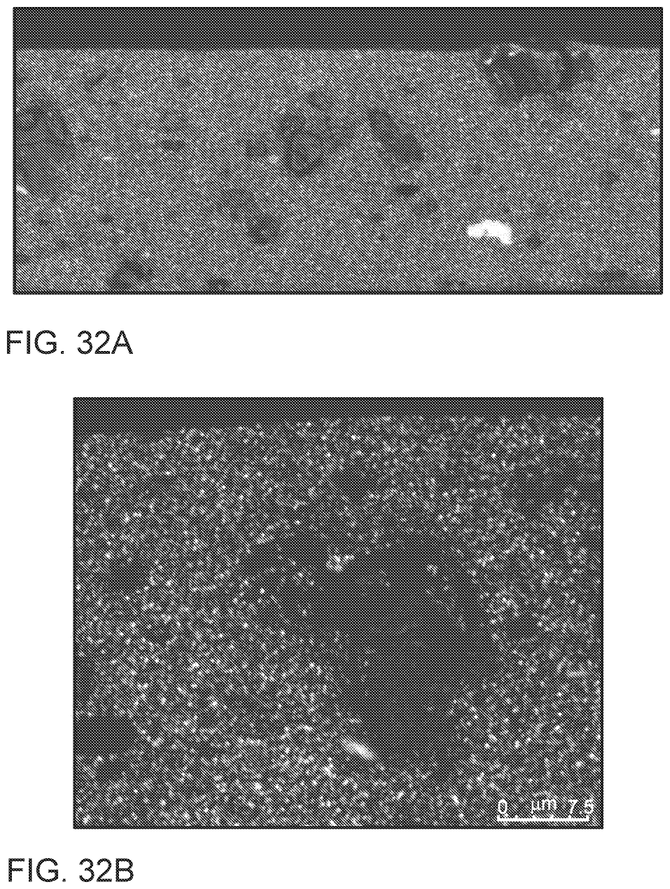

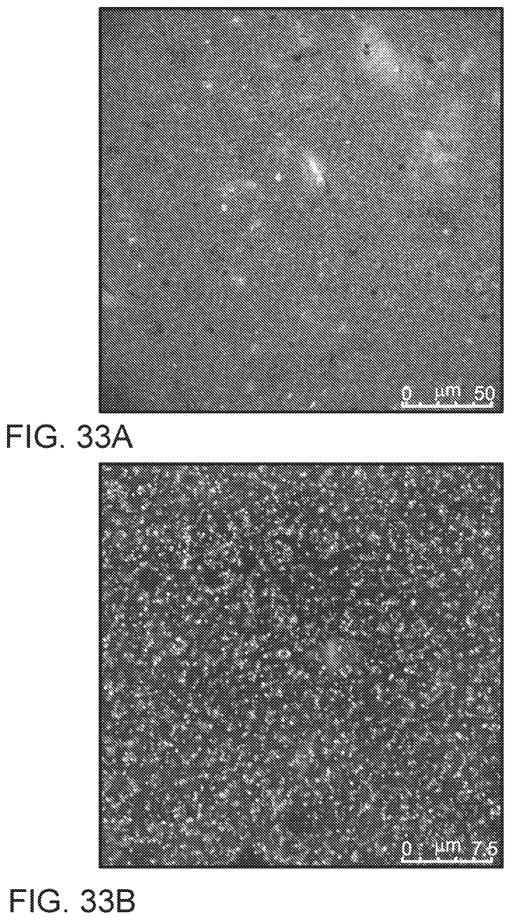

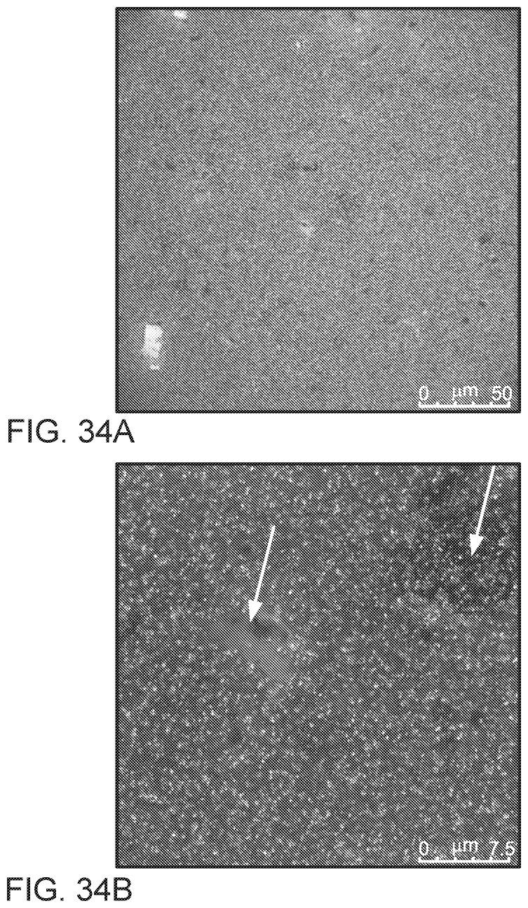

A cellulase enzyme (Pyrolase HT) was covalently labeled by a fluorescence dye (fluorescein), which was then added to liquid paint samples; paint films were drawn down and dried. The enzyme distribution was visualized in dry paint film (at both the bottom surface and at a cross section) using confocal laser scanning microscopy (CLSM). Both low and high magnification images were captured, where the grey color is due to light scattering from the TiO₂ pigment and the fluorescence glow is due to the fluorescently labeled enzyme. Microscopic analysis of a cross section of paint film comprising Minex filler [(NaK)Al₂(AlSi₃)O₁₀(OH)₂] revealed that enzyme distribution appeared as small particles and greater domains, possibly located on some filler particles (FIG. 31). FIG. 32 shows a cross section of paint film comprising Duramite filler (CaCO3), where a slight gradient in the distribution of enzyme towards the surface was observed and the enzyme appeared to be located predominantly on filler particles. A homogenous fluorescence was observed over the whole image of a bottom view of paint film comprising Minex filler, with some bright areas seen (FIG. 33). CLSM visualization of bottom view of paint film comprising Duramite filler also yielded a homogenous fluorescence over the whole image (FIG. 34), with some areas which are free of enzymes and other areas where enzymes adsorb strongly (likely CaCO₃ filler) (indicated by arrows in FIG. 34B).

These microscopic analyses revealed a generally inhomogeneous distribution of enzyme in the dry paint samples. Enzymes appeared to migrate toward the surface of the film and form a gradient across the film. Adsorption onto the filler particles within the film and unspecified agglomerates was further observed. In liquid paint samples, the enzyme appears inhomogeneously distributed, and is predominantly in the water phase, which forms a separate phase besides a TiO₂/binder phase in liquid paint. No adsorption of enzyme on filler particles is observed in liquid paint, neither for the Minex nor for the Duramite fillers.

### Visualization of In Situ Enzyme Activity in Film

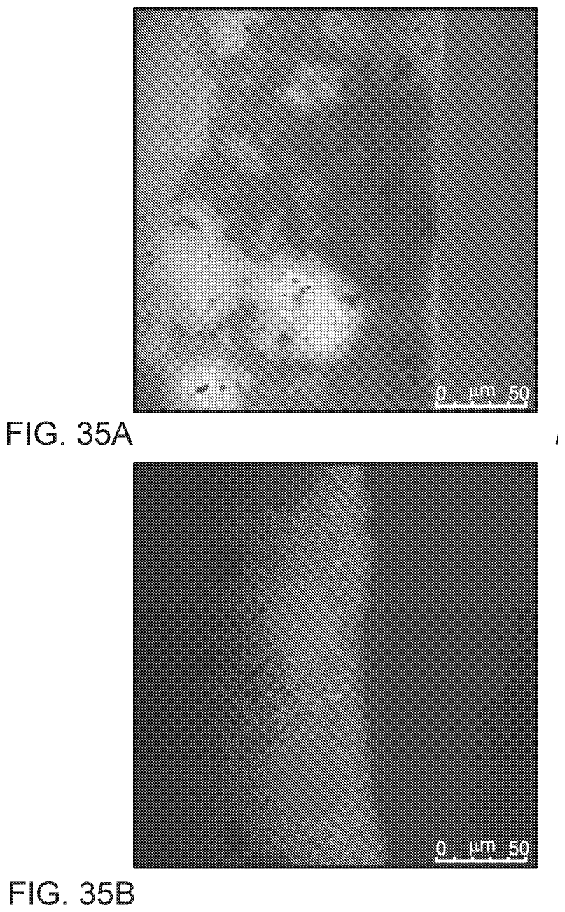

To visualize in-film enzyme activity, a substrate solution (Resorufin Cellubioside) was applied at the edge or cross section of paint film. A substrate solution (100 μmol Resorufin Cellubioside) was applied at the edge of the film, and as the substrate is converted by cellulase enzyme, released Resorufin dye fluoresces. FIG. 35 shows confocal laser scanning microscopy visualization of enzyme activity in a paint film comprising Minex filler [(NaK)Al₂(AlSi₃)O₁₀(OH)₂]. An overlay of reflection and fluorescence shows a grey reflection due to scattering from the TiO₂ pigment, while the fluorescence glow is due to the release of fluorescence dye Resorufin from substrate Resorufin Cellubioside by cellulase activity. Substrate conversion to product by the enzyme is observed within the film (FIG. 35). The converted product (dye) or the enzymes was seen to diffuse into the surrounding solution phase as well. Interestingly, penetration of fluorescence into the film is slower in the lower PVC sample (FIG. 35B).

In conclusion, the conversion of the substrate (Resorufin Cellubioside) by enzyme can be visualized in the paint film. Interestingly, the penetration of the substrate into the film and subsequent enzymatic conversion is faster in higher PVC sample. The released fluorescent dye from the enzymatic reaction, Resorufin, is enriched at the interface of the filler particle. However, the free dye molecule itself is slightly hydrophobic and also adsorbs stronger at interfaces of the filler particles. Therefore, one cannot conclude directly that the enzyme is located predominately at these interfaces. Collectively, these studies provide further proof of principle that multiple classes of enzymes directly embedded in wet paint retain their activity, and further that they remain active following film formation.

### Example 7: Lactonate Activity from Paint Extracts

Recovery of lactonase activity was tested in enzyme extract from paint samples embedded with lactonase. Briefly, lactonase was added to and mixed in wet paint dispersions depicted in Table 8, comprising Minex 4 ((NaK)Al₂(AlSi₃)O₁₀(OH)₂) as filler and a PVC of either 40% (High PVC) or 20% (Low PVC), at an enzyme concentration of 0.2%. Paint film was then drawn down and dried at ambient condition. The dry film samples were stored at room temperature for 7 days before analysis.

TABLE 8
PAINT FORMULATIONS EMBEDDED WITH LACTONASE

| Raw Materials | High PVC | Low PVC |
|---|---|---|
| Water | 180.7 | 123.0 |
| AEPD VOX 1000 | 1.5 | 1.7 |
| Dispex CX 4340 | 4.0 | 4.6 |
| Foamstar ST 2420 | 2.0 | 2.3 |
| Proxel DB 20 | 3.0 | 3.5 |
| Kronos 2310 | 200.0 | 97.7 |
| Minex 4 | 200.0 | 97.7 |
| Attagel 50 | 4.0 | 4.6 |
| Grind for 10-15 min, then add: | | |
| Water | 75.0 | 57.5 |
| Foamstar ST 2420 | 2.0 | 2.3 |
| Hydropalat WE 3320 | 2.0 | 2.3 |
| Loxanol CA 5320 | 9.0 | 10.3 |
| Acronal EDGE 4750 | 425.0 | 564.9 |
| Rheovis PE 1331 | 12.5 | 14.4 |
| Rheovis PU 1191 | 1.0 | 1.2 |
| Total grams (equiv. to lbs/100 gal) | 1121.7 | 987.8 |
| Viscosity target | 95-100 | 95-100 |
| Viscosity target | 1.0-1.5 | 1.0-1.5 |
| Volume Solids | 39% | 39% |
| PVC | 40% | 20% |

The enzyme was extracted by incubating dry paint film with a buffer consisting of 50 mM HEPES pH 8.0, 150 mM NaCl, and 0.2 mM CoCl₂, for one hour at 60° C. with gentle agitation. The samples were centrifuged at 18,000×g for 5 minutes to pellet the insoluble paint, and the supernatant containing the extracted enzyme was used for activity assay. The enzyme activities in the extracts were analyzed by an HPLC method. Briefly, 90 μL of extracted supernatant was mixed with 10 μL of 5 mM substrate (3-oxo-C12 acylhomoserine lactone) and then incubated at room temperature for 30 minutes. The reaction was quenched by addition of 70 μL of ice-cold acetonitrile, and the samples were centrifuged for 10 minutes at 18,000×g. Twenty μL of supernatant was injected on a reversed-phase HPLC column; the substrate and product were separated using an isocratic elution with a mobile phase of 75% acetonitrile/0.2% formic acid. Solutions with free/fresh lactonase (+ solution control), no lactonase (−solution control), and extracted dry film without enzyme added (−dry film control) served as control samples.

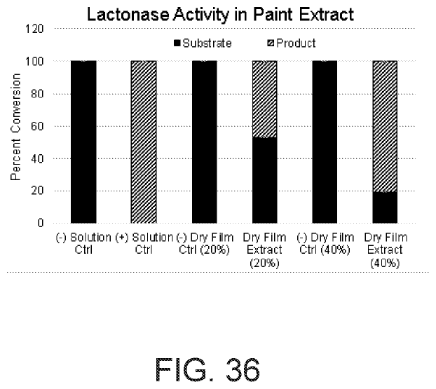

FIG. 36 shows the recovered enzyme activities, expressed as the percent of substrate-to-product conversion. While the extract from the (−) solution control and (−) dry film control (no enzyme added) exhibited no turnover, the (+) solution control sample (free/fresh enzyme solution) showed complete substrate conversion to product. The samples extracted from the dry films containing the enzyme displayed significant conversion, and the recovered enzyme activity was higher from the higher PVC film. This experiment further provided proof of concept that the activity of lactonase enzyme directly embedded in wet paint can be recovered following film formation.

In at least some of the previously described embodiments, one or more elements used in one embodiment can interchangeably be used in another embodiment unless such a replacement is not technically feasible. It will be appreciated by those skilled in the art that various other omissions, additions and modifications may be made to the methods and structures described above without departing from the scope of the claimed subject matter. All such modifications and changes are intended to fall within the scope of the subject matter, as defined by the appended claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 15 articles refers to groups having 1, 2, 3, 4, or 5 articles, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

All references cited herein, including patents, patent applications, papers, text books, and the like, and the references cited herein, to the extent that they are not already, are hereby incorporated by reference in their entirety. In the event that one or more of the incorporated literature and similar materials differ from or contradict this application, including but not limited to defined terms, term usage, described techniques, or the like, this application controls.

What is claimed is:

1. A coating composition comprising a binder, a pigment, and one or more enzymes, wherein the coating composition is capable of forming a film when applied to a surface, wherein the pigment volume concentration (PVC) of the coating composition is below the critical pigment volume concentration (CPVC), and wherein at least one of the one or more enzymes retains at least about 5% activity in-film.

2. The composition of claim 1, wherein the one or more enzymes retain at least about 30% activity in the coating composition before it is applied to the surface.

3. The composition of any one of claims 1-2, wherein at least one of the one or more enzymes has one or more of the following properties: is not chemically modified, is in its native form, is incorporated directly in the coating composition, is not immobilized on a support, and is not covalently attached to the binder prior to film formation.

4. The composition of any one of claims 1-3, wherein the coating composition does not comprise whole cell particulate material.

5. The composition of any one of claims 1-4, wherein the PVC is about 0.001% to about 70%.

6. The composition of any one of claims 1-5, wherein about 0.001 wt % to about 20 wt % of the coating composition is the one or more enzymes.

7. The composition of any one of claims 1-6, wherein the one or more enzymes comprise an oxidoreductase, a transferase, a hydrolase, a lyase, an isomerase, a ligase, or any combination thereof.

8. The composition of any one of claims 1-7, wherein the one or more enzymes comprise a mannanase, a cellulase, an amylase, a lipase, a protease, a laccase, a urease, a lactonase, or any combination thereof.

9. The composition of any one of claims 1-8, wherein the activity of the one or more enzymes confers one or more of the following properties to the coating composition: self-cleaning, stain resistance, stain blocking, tannin blocking, adhesion, paint processing aid, formaldehyde abatement, odor abatement, corrosion resistance, anti-microbial, anti-biofilm, de-greasing, de-icing, decontamination, strippable coating, faster curing, and lower VOC content.

10. The composition of any one of claims 1-9, wherein the coating composition comprises an industrial coating, a marine coating, an automotive coating, an architectural coating, or any combination thereof.

11. The composition of any one of claims 1-10, wherein the coating composition comprises a paint, a lacquer, a printing ink, a varnish, a shellac, a stain, a textile finish, a sealing compound, a water repellent coating, or any combination thereof.

12. The composition of any one of claims 1-11, wherein the surface comprises wood, metal, masonry, plaster, stucco, plastic, or any combination thereof.

13. The composition of any one of claims 1-12, wherein the coating composition comprises a water-borne coating, and wherein the water-borne coating is a latex coating.

14. The composition of any one of claims 1-13, wherein the binder comprises an oil-based binder, a polyester resin, a modified cellulose, a polyamide, an amino resin, a urethane binder, a phenolic resin, an epoxy resin, a polyhydroxyether binder, an acrylic resin, a polyvinyl binder, a rubber resin, a bituminous binder, a polysulfide binder, a silicone binder, an organic binder, or any combination thereof.

15. The composition of any one of claims 1-14, wherein the binder comprises or is derived from vinyl monomers, butadiene copolymers, vinyl acetate copolymers, styrene acrylic copolymers, acrylic copolymers, Acronal PLUS 4670, Acronal EDGE 4750, Joncryl PRO 1522, Joncryl PRO 1524, or any combination thereof.

16. The composition of any one of claims 1-15, wherein the pigment comprises a color pigment, an extender pigment (a filler), a corrosion resistance pigment, a camouflage pigment, or any combination thereof.

17. The composition of claim 16, wherein the color pigment comprises or is derived from an organic pigment, an inorganic pigment, an anionic pigment dispersion, a cationic pigment dispersion, azo chelate pigments, insoluble azo pigments, condensed azo pigments, phthalocyanine pigments, indigo pigments, perinone pigments, perylene pigments, dioxane pigments, quinacridone pigments, isoindolinone pigments, metal complex pigments, chrome yellow, yellow iron oxide, iron oxide red, carbon black and titanium dioxide; and extender pigments such as calcium carbonate, barium sulfate, clay, talc, TiO₂ (anatase), TiO₂ (rutile), clay (aluminum silicate), CaCO₃ (ground), CaCO₃ (precipitated), aluminum oxide, silicon dioxide, magnesium oxide, talc (magnesium silicate), baryte (barium sulfate), zinc oxide, zinc sulfite, sodium oxide, potassium oxide, MINEX, CELITE, ATOMITE, or any combination thereof.

18. The composition of claim 16, wherein the extender pigment comprises or is derived from attapulgite clay, TiO₂, CaCO₃, kaolin clay, nepheline syenite, (25% nepheline, 55% sodium feldspar, and 20% potassium feldspar), feldspar (an aluminosilicate), diatomaceous earth, calcined diatomaceous earth, talc (hydrated magnesium silicate), aluminosilicates, silica (silicon dioxide), alumina (aluminum oxide), alumina trihydrate (ATM), mica (hydrous aluminum potassium silicate), pyrophyllite (aluminum silicate hydroxide), perlite, baryte (barium sulfate), wollastonite (calcium metasilicate), Mg₃Si₄O₁₀(OH)₂, BaSO₄, (NaK)Al₂(AlSi₃)O₁₀(OH)₂, CaCO₃, Al₂Si₂O₅(OH)₄, SiO₂, KAl₂(AlSi₃O₁₀)(OH)₂, or any combination thereof.

19. The composition of any one of claims 1-18, further comprising one or more additives selected from the group comprising a neutralizer, a rheology modifier, a dispersant, a coalescing agent, a plasticizer, a defoamer, a stabilizer, a humectant, a wetting agent, a dye, a biocide, and a combination thereof.

20. The composition of claim 19, wherein the rheology modifier is selected from the group comprising hydrophobically modified ethylene oxide urethane (HEUR) polymers, hydrophobically modified alkali soluble emulsion (HASE) polymers, hydrophobically modified hydroxyethyl celluloses (HMHECs), hydrophobically modified polyacrylamide, acrylic copolymer dispersions, urethanes, hydroxyethyl cellulose, guar gum, jaguar, carrageenan, xanthan, acetan, konjac, mannan, xyloglucan, urethanes, and a combination thereof.

21. The composition of any one of claims 19-20, wherein the coalescing agent is selected from the group comprising ethylene glycol monomethyl ether, ethylene glycol monobutyl ether, ethylene glycol monoethyl ether acetate, ethylene glycol monobutyl ether acetate, diethylene glycol monobutyl ether, diethylene glycol monoethyl ether acetate, dipropylene glycol monomethyl ether, propylene glycol n-butyl ether, dipropylene glycol n-butyl ether (DPnB), 2,2,4-trimethyl-1,3-pentanediol monoisobutyrate (Texanol), and a combination thereof.

22. The composition of any one of claims 19-21, wherein the coalescing agent is present in an amount of at least about 8.0 wt %, wherein in-film enzyme activity increased by at least about 5% compared to a coating composition comprising the coalescing agents in an amount of less about 6.0 wt %.

23. A method of maintaining the in-film activity of an enzyme in a coating composition, wherein the method comprises adding one or more enzymes to a coating composition comprising a pigment and a binder, wherein the pigment volume concentration (PVC) of the coating composition is below the critical pigment volume concentration (CPVC), wherein the enzyme is selected from the group consisting of a mannanase, a cellulase, an amylase, a lipase, a protease, a laccase, a lactonase, and a combination thereof, wherein the in-film enzyme activity increased by at least about 5% compared to a coating composition with a PVC of less than about 20%.

24. A method of maintaining the in-film activity of an enzyme in a coating composition, wherein the method comprises adding one or more enzymes to a coating composition comprising a pigment and a binder, wherein the pigment volume concentration (PVC) of the coating composition is below the critical pigment volume concentration (CPVC), wherein the one or more enzymes is a urease, wherein the in-film enzyme activity increased by at least about 5% compared to a coating composition with a PVC of greater than about 20%.

25. A method of using an enzyme-containing coating composition, comprising applying a coating composition of any one of claims 1-22 to a surface, wherein the applying the coating composition to the surface confers one or more of the following properties to the surface: self-cleaning, stain resistance, stain blocking, tannin blocking, wood adhesion, paint processing aid, formaldehyde abatement, odor abatement, corrosion resistance, anti-microbial, anti-biofilm, de-greasing, de-icing, decontamination, strippable coating, faster curing, and lower VOC content.
